(19) United States
(12) Patent Application Publication
(10) Pub. No.: US 2015/0213474 A1
(43) Pub. Date: Jul. 30, 2015

(54) APPARATUS, METHOD, AND COMPUTER PROGRAM PRODUCT FOR TRANSIT POOLING USING PAYMENT CARD DATA

(71) Applicant: MasterCard International Incorporated, Purchase, NY (US)

(72) Inventor: Justin Xavier Howe, Oakdale, NY (US)

(73) Assignee: MasterCard International Incorporated, Purchase, NY (US)

(21) Appl. No.: 14/164,599

(22) Filed: Jan. 27, 2014

(51) Int. Cl. G06Q 30/02; G06Q 20/34; G07B 15/00

(52) U.S. Cl. CPC G06Q 30/0222; G07B 15/00; G06Q 20/355

(57) ABSTRACT

Using payment card transaction data, residence locations are estimated for a plurality of payment card holders and recurrent destinations are estimated for at least a first portion of the plurality of payment card holders. A plurality of pooled transit pick-up points are identified in a geographic region of interest. Each of at least a second portion of the payment card holders are assigned to at least one of the pooled transit pick-up points. At least some of the payment card holders assigned to at least one of the pick-up points are identified as potential riders of a pooled transit service

### FIELD OF THE DISCLOSURE

The present disclosure relates generally to the electronic and computer arts, and, more particularly, to utilization of electronic payment data.

### BACKGROUND OF THE DISCLOSURE

The use of payment cards, such as credit cards, debit cards, and pre-paid cards, has become ubiquitous. Most payment card accounts have one or more associated physical cards; however, the use of non-traditional payment devices, such as appropriately configured “smart” cellular telephones, is increasing. A wealth of transaction data is available, based on the use of payment card accounts.

A geographic information system (GIS) captures, stores, manipulates, analyzes, manages, and/or presents geographical data. A GIS makes and manipulates spatial areas that may be jurisdictional, purpose, or application-oriented.

Route planning software plans an (optimal) route between two geographical locations using a journey planning engine, typically specialized for road networks as a road route planner.

### SUMMARY OF THE DISCLOSURE

Principles of the present disclosure provide techniques for transit pooling using payment card data. At least some aspects of the techniques may be facilitated by the operator of a payment network or other service provider.

In one aspect, an exemplary method includes the steps of, using payment card transaction data, estimating residence locations for a plurality of payment card holders; using payment card transaction data, estimating recurrent destinations for at least a first portion of the plurality of payment card holders; identifying a plurality of pooled transit pick-up points in a geographic region of interest; assigning each of at least a second portion of the payment card holders to at least one of the pooled transit pick-up points; and identifying at least some of the payment card holders assigned to at least one of the pick-up points as potential riders of a pooled transit service.

Aspects of the disclosure contemplate the method(s) performed by one or more entities herein, as well as facilitating of one or more method steps by the same or different entities. As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the disclosure or elements thereof can be implemented in the form of a computer program product including a tangible computer readable recordable storage medium with computer usable program code for performing the method steps indicated stored thereon in a non-transitory manner. Furthermore, one or more embodiments of the disclosure or elements thereof can be implemented in the form of a system (or apparatus) including a memory and at least one processor that is coupled to the memory and operative to perform exemplary method steps. Yet further, in another aspect, one or more embodiments of the disclosure or elements thereof can be implemented in the form of means for carrying out one or more of the method steps described herein; the means can include (i) specialized hardware module(s), (ii) software module(s) stored in a non-transitory manner in a tangible computer-readable recordable storage medium (or multiple such media) and implemented on a hardware processor, or (iii) a combination of (i) and (ii); any of (i)-(iii) implement the specific techniques set forth herein. Transmission medium(s) per se and disembodied signals per se are defined to be excluded from the claimed means.

One or more embodiments of the disclosure can provide substantial beneficial technical effects, including:
provision of targeting and prioritization with anonymized data;
ability to distinguish mass transit users from non-mass transit users by using spend and/or payments data—this distinction is difficult to make with telecom data;
ability to target transit users based on geography and spend data without needing to link disparate geographical and spend data sources, as opposed to methods that focus on use of geolocation data with inferred demographic characteristics rather than granular ones;
ability to undertake pre-registration targeting by using spend data, as opposed to systems that require opt in first.

These and other features and advantages of the present disclosure will become apparent from the following detailed description of illustrative embodiments thereof, which is to be read in connection with the accompanying drawings.

### BRIEF DESCRIPTION OF THE DRAWINGS

FIG. 1 shows an example of a system and various components thereof that can implement at least a portion of some techniques of the disclosure;

FIG. 2 depicts an exemplary inter-relationship between and among: (i) a payment network configured to facilitate transactions between multiple issuers and multiple acquirers, (ii) a plurality of users, (iii) a plurality of merchants, (iv) a plurality of acquirers, and (v) a plurality of issuers, as well as an exemplary database, useful in connection with one or more embodiments of the disclosure;

FIG. 3 shows a map with pertinent aspects for transit pooling, in accordance with an aspect of the disclosure; FIG. 4 shows an exemplary system block diagram, in accordance with an aspect of the disclosure;

FIG. 5 is a block diagram of an exemplary computer system useful in one or more embodiments of the disclosure;

FIG. 6 is a flow chart of an exemplary method, in accordance with an aspect of the disclosure;

FIG. 7 is a block diagram illustrating a system for aggregating consumer spending behaviors in accordance with exemplary embodiments of U.S. patent application Ser. No. 13/721,216;

FIG. 8 is a block diagram illustrating the processing server of the system of FIG. 6 in accordance with exemplary embodiments of U.S. patent application Ser. No. 13/721,216;

FIG. 9 is a block diagram illustrating the consumer database of FIG. 6 in accordance with exemplary embodiments of U.S. patent application Ser. No. 13/721,216;

FIG. 10 is a block diagram illustrating the geographic database of FIG. 6 in accordance with exemplary embodiments of U.S. patent application Ser. No. 13/721,216;

FIG. 11 is a diagram illustrating a plurality of geographic areas and corresponding geographic centroids in accordance with exemplary embodiments of U.S. patent application Ser. No. 13/721,216;

FIG. 12 is a diagram illustrating a plurality of financial transactions and identification of a purchase centroid in accordance with exemplary embodiments of U.S. patent application Ser. No. 13/721,216;

FIG. 13 is a diagram illustrating the identification of a predetermined number of geographic centroids in accordance with exemplary embodiments of U.S. patent application Ser. No. 13/721,216;

FIG. 14 is a flow chart illustrating a method for aggregating consumer spending behaviors in geographic areas in accordance with exemplary embodiments of U.S. patent application Ser. No. 13/721,216; and

FIG. 15 is a flow chart illustrating an exemplary method for assigning consumer behaviors to geographic areas in accordance with exemplary embodiments of U.S. patent application Ser. No. 13/721,216.

### DETAILED DESCRIPTION OF PREFERRED EMBODIMENTS

At least some embodiments employ payment card data or the like for transit pooling.

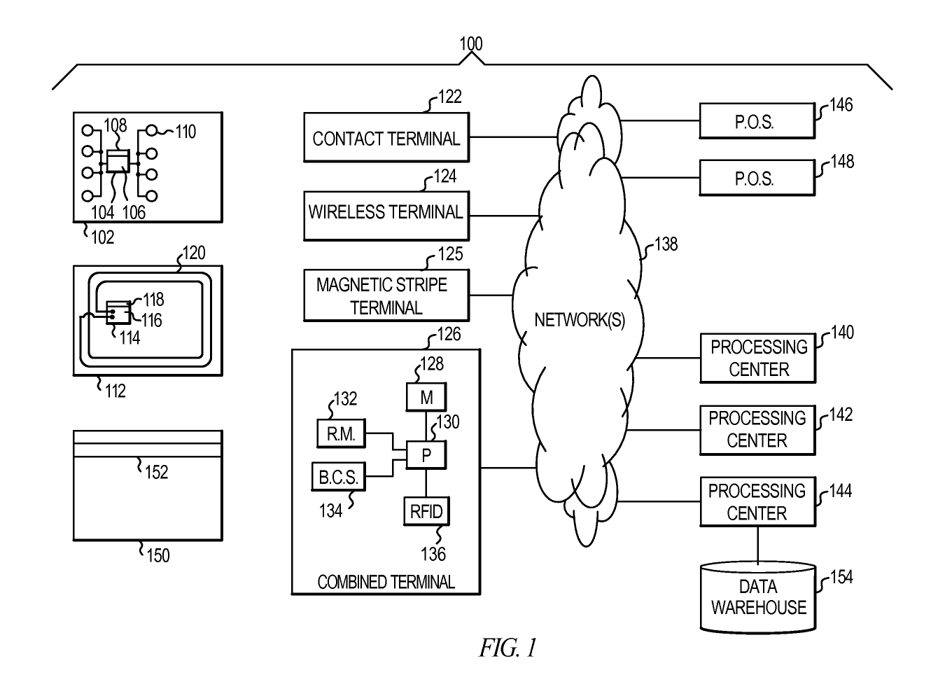

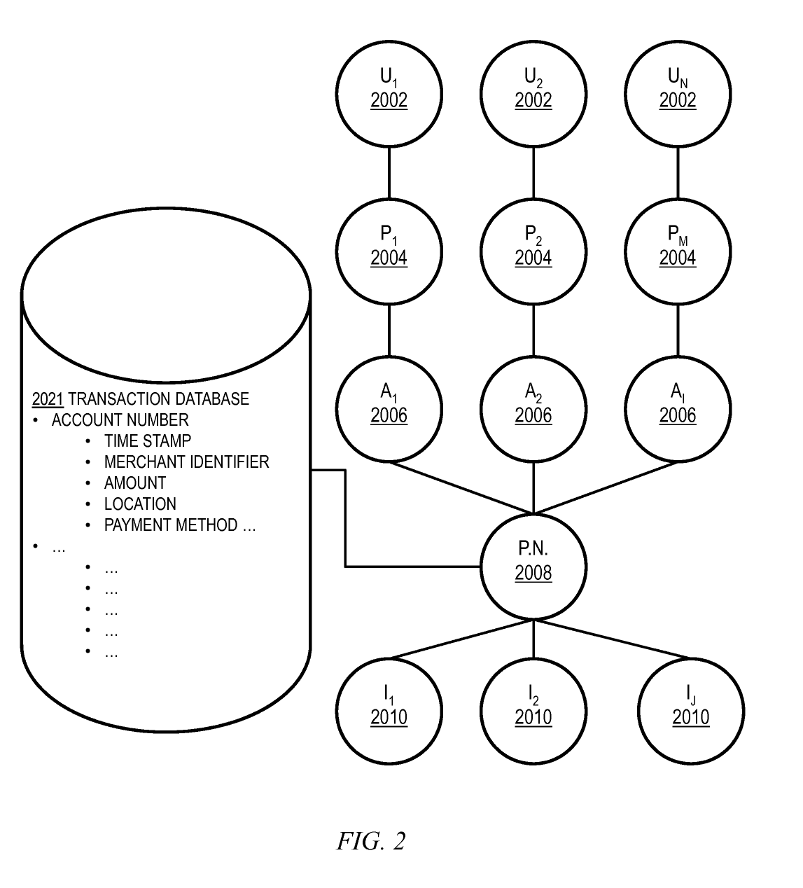

With regard to payment card and similar payments, attention should now be given to FIG. 1, which depicts an exemplary embodiment of a system 100, according to an aspect of the disclosure, and including various possible components of the system. System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. Some embodiments employ BLUETOOTH® technologies such as Bluetooth low energy (Bluetooth LE)(mark of BLUETOOTH SIG, INC. Kirkland, Wash., USA). An oscillator or oscillators, and/or additional appropriate circuitry for one or more of modulation, demodulation, downconversion, and the like can be provided. Note that cards 102, 112 are exemplary of a variety of devices that can be employed. The system 100 typically functions with other types of devices in lieu of or in addition to “smart” or “chip” cards 102, 112; for example, a conventional card 150 having a magnetic stripe 152. Furthermore, an appropriately configured mobile device (e.g., “smart” cellular telephone handset, tablet, personal digital assistant (PDA), fobs, watches, and the like) can be used to carry out contactless payments in some instances.

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's primary account number (“PAN”) and/or personal identification number (“PIN”). The memory portions of units 108, 118 can store the operating system of the cards 102, 112. The operating system loads and executes applications and provides file management or other basic card services to the applications. One operating system that can be used to implement some aspects or embodiments of the present disclosure is the MULTOS® operating system licensed by MAOSCO Limited. (MAOSCO Limited, St. Andrews House, The Links, Kelvin Close, Birchwood, Warrington, WA3 7PB, United Kingdom) Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications. At present, one possible specification to which such applications may conform is the EMV interoperable payments specification set forth by EMVCo, LLC (901 Metro Center Boulevard, Mailstop M3-3D, Foster City, Calif., 94404, USA). It will be appreciated that applications can be configured in a variety of different ways.

The skilled artisan will also be familiar with the MasterCard® PayPass™ specifications, available under license from MasterCard International Incorporated of Purchase, N.Y., USA (marks of MasterCard International Incorporated of Purchase, N.Y., USA).

As noted, cards 102, 112 are examples of a variety of payment devices that can be employed. The primary function of the payment devices may not be payment, for example, they may be cellular phone handsets that implement appropriate techniques. Such devices could include cards having a conventional form factor, smaller or larger cards, cards of different shape, key fobs, personal digital assistants (PDAs), appropriately configured cell phone handsets, watches, or indeed any device with the appropriate capabilities. In some cases, the cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to execute one or more steps. The applications can be, for example, application identifiers (AIDs) linked to software code in the form of firmware plus data in a card memory such as an electrically erasable programmable read-only memory (EEPROM).

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any combination of devices 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can, in general, be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network (e.g., a virtual private network (VPN) such as is described with respect to FIG. 2 below). More than one network could be employed to connect different elements of the system. For example, a local area network (LAN) could connect a terminal to a local server or other computer at a retail establishment or the like. A payment network could connect acquirers and issuers. Further details regarding one specific form of payment network will be provided below. Processing centers 140, 142, 144 can include, for example, a host computer of an issuer of a payment device.

Many different retail or other establishments, represented by points-of-sale 146, 148, can be connected to network 138. Different types of portable payment devices, terminals, or other elements or components can combine or “mix and match” one or more features depicted on the exemplary devices in FIG. 1.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to perform one or more steps of methods and techniques. The processor can perform such operations via hardware techniques, and/or under the influence of program instructions, such as an application, stored in one of the memory units.

The portable device can include a body portion. For example, this could be a laminated plastic body (as discussed above) in the case of “smart” or “chip” cards 102, 112, or the handset chassis and body in the case of a cellular telephone.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module such as 132 that is coupled to the processor and configured to interface with the portable apparatuses 102, 112, 142. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138. The aforementioned bar code scanner 134 and/or RFID tag reader 136 can optionally be provided, and can be coupled to the processor, to gather attribute data, such as a product identification, from a UPC code or RFID tag on a product to be purchased.

The above-described devices 102, 112 can be ISO 7816-compliant contact cards or devices or NFC (Near Field Communications) or ISO 14443-compliant proximity cards or devices. In operation, card 112 can be touched or tapped on the terminal 124 or 128 (or an associated reader), which then contactlessly transmits the electronic data to the proximity IC chip in the card 112 or other wireless device.

One or more of the processing centers 140, 142, 144 can include a database such as a data warehouse 154.

It should be noted that the system depicted in FIG. 1 may involve not only conventional transactions at “brick and mortar” merchants, but also, e.g., e-commerce, such as card-not-present Internet transactions. In some instances, an Internet Protocol (IP) address may be captured during such a transaction. In some instances, data from such card-not-present Internet transactions can be used, for example, to infer a cardholder's home address. In some cases, an individual utilizes his or her home computer to communicate with a server of an e-commerce merchant over the Internet. The individual provides his or her PAN to the merchant's server. The merchant utilizes the PAN to initiate an authorization request, and upon receiving an authorization request response indicating approval, will complete the e-commerce transaction.

In some cases, there can be payment card accounts which do not have physical cards or other physical payment devices associated therewith; for example, a customer can be provided with a PAN, expiration date, and security code but no physical payment device, and use same, for example, for card-not-present telephone or internet transactions.

With reference to FIG. 2, an exemplary relationship among multiple entities is depicted. A number of different users (e.g., consumers) 2002, U₁, U₂ . . . U_{N}, interact with a number of different merchants 2004, P₁, P₂ . . . P_{M}. Merchants 2004 interact with a number of different acquirers 2006, A₁, A₂ . . . A_{I}. Acquirers 2006 interact with a number of different issuers 2010, I₁, I₂ . . . I_{J}, through, for example, a single operator 2008 of a payment network configured to facilitate transactions between multiple issuers and multiple acquirers; for example, MasterCard International Incorporated, operator of the BANKNET® network, or Visa International Service Association, operator of the VISANET® network. In general, N, M, I, and J are integers that can be equal or not equal. Note that some embodiments make use of Member Service Providers (MSPs) (third parties that provide processing services or the like).

During a conventional credit authorization process, the cardholder 2002 pays for the purchase and the merchant 2004 submits the transaction to the acquirer (acquiring bank) 2006. The acquirer verifies the card number, the transaction type and the amount with the issuer 2010 and reserves that amount of the cardholder's credit limit for the merchant. At this point, the authorization request and response have been exchanged, typically in real time. Authorized transactions are stored in “batches,” which are sent to the acquirer 2006. During subsequent clearing and settlement, the acquirer sends the batch transactions through the credit card association, which debits the issuers 2010 for payment and credits the acquirer 2006. Once the acquirer 2006 has been paid, the acquirer 2006 pays the merchant 2004.

Transaction database 2021 is discussed below.

It will be appreciated that the network 2008 shown in FIG. 2 is an example of a payment network configured to facilitate transactions between multiple issuers and multiple acquirers, which may be thought of as an “open” system. Some embodiments of the disclosure may be employed in connection with payment card accounts using other kinds of payment networks, for example, proprietary or closed payments networks with only a single issuer and acquirer. Furthermore in this regard, FIG. 2 depicts a four party model, as will be known to the skilled artisan; the four parties are the consumer 2002, merchant 2004, acquirer 2006, and issuer 2010. However, at least some embodiments are also of use with three-party models, wherein the acquirer and issuer (and in at least some instances, the network operator, as well) are the same entity.

Messages within a network such as network 138 and/or network 2008, may, in at least some instances, conform to the International Organization for Standardization (ISO) Standard 8583, Financial transaction card originated messages—Interchange message specifications, which is the ISO standard for systems that exchange electronic transactions made by cardholders using payment cards. It should be noted that the skilled artisan will be familiar with the ISO 8583 standards. Nevertheless, out of an abundance of caution, the following documents are expressly incorporated herein by reference in their entirety for all purposes (published by ISO, Geneva, Switzerland, and available on the ISO web site):
ISO 8583 Part 1: Messages, data elements and code values (2003)
ISO 8583 Part 2: Application and registration procedures for Institution Identification Codes (IIC) (1998)
ISO 8583 Part 3: Maintenance procedures for messages, data elements and code values (2003)
ISO 8583:1993 (1993)
ISO 8583:1987 (1987)

As used herein, a “payment card network” is a communications network that uses payment card account numbers, such as primary account numbers (PANs), to authorize, and to facilitate clearing and settlement of, payment card transactions for credit, debit, stored value and/or prepaid card accounts. The card accounts have standardized payment card account numbers associated with them, which allow for efficient routing and clearing of transactions; for example, ISO standard account numbers such as ISO/IEC 7812-compliant account numbers. The card accounts and/or account numbers may or may not have physical cards or other physical payment devices associated with them.

For example, in some instances, organizations have purchasing card accounts to which a payment card account number is assigned, used for making purchases for the organization, but there is no corresponding physical card. In other instances, “virtual” account numbers are employed; this is also known as PAN mapping. The PAN mapping process involves taking the original Primary Account Number (PAN)(which may or may not be associated with a physical card) and issuing a pseudo-PAN (or virtual card number) in its place. Commercially available PAN-mapping solutions include those available from Orbiscom Ltd., Block 1, Blackrock Business Park, Carysfort Avenue, Blackrock, Co. Dublin, Ireland (now part of MasterCard International Incorporated of Purchase, N.Y., USA); by way of example and not limitation, techniques of U.S. Pat. Nos. 6,636,833 and 7,136,835 of Flitcroft et al., the complete disclosures of both of which are expressly incorporated herein by reference in their entireties for all purposes. It is worth noting that in one or more embodiments, single use PANS are only valuable to the extent that they can be re-mapped to the underlying account, cardholder, or household.

Some payment card networks connect multiple issuers with multiple acquirers; others use a three party model. Some payment card networks use ISO 8583 messaging. Non-limiting examples of payment card networks that connect multiple issuers with multiple acquirers are the BANKNET® network and the VISANET® network. Other kinds of payment data are also useful in one or more embodiments of the disclosure; e.g., PIN transactions (aka ‘Single Message’), ATM non-financial transactions (i.e. balance inquiry, transfer, etc.), and the like.

One or more embodiments provide transit pooling using payment card data. In one aspect, a pooled livery service is provided, wherein people sign up for a customized ad hoc bus route, even if they are in an area that does not have mass transit. For example, in many areas such as Washington, D.C., the New York metropolitan area, and the like, transit systems are generally set up to transport people to the city center; however, getting around from one suburb to another may be difficult without going into the city center and back. There may be significant numbers of people undertaking the same or similar suburb-to-suburb commutes, but these people may not know each other and/or may not know how to organize to arrange a pooled transportation service. These people may never have considered that such an approach could reduce commuting-related costs and/or stress.

A number of different people or entities could provide such a transit pooling service. In some instances, an employer could provide such a service to its employees.

In one or more embodiments, the operator of a payment card network (e.g., 2008) provides some or all aspects of such a service. Such an operator has access to payment data which advantageously allows one, some, or all of the following:
1. inferring where people live and where they are travelling to
2. determining whether people are already commuting to work on mass transit (payment network operator can determine from payment data)
3. determining how much a person is already spending on transportation such as maintenance, fuel costs, and the like
4. knowing where the person works (possibly with the aid of available demographic information on the traveler)

One or more embodiments are also quite attractive because they cost little or nothing to test and implement. An interested entity can contact a few companies and easily obtain estimates regarding what it would cost to set up such a livery service and run it for a one-day test period, and could potentially try it out first, internally, with its own employees.

Referring now to FIG. 4, one or more embodiments employ a geographic information system (GIS) 406 including a database management system 408, an analysis engine 410, and a user interface (UI) module 414. Database management system 408 accesses records in, and operates on, a geographic database 412, a transaction database 2021, and optionally a consumer database 418. GIS 406 provides output at 416.

Non-limiting exemplary consumer database output formats include PAN, Residential Zip Code, Workplace Zip Code, Commuting Expense, commuting distance, traveling workplace flag, employed flag, depart time, and arrive time. Other types of postal codes could be used outside the US. One non-limiting exemplary transaction format is ISO 8583.

Geographic information systems, such as GIS 408 accessing database 412, are a specific type of database program. Non-limiting examples of GIS software are those available from ESRI of Redlands, Calif., USA, and MapInfo products, available from Pitney Bowes of Stamford, Conn., USA. Both of these products are useful for analytical purposes. One or more embodiments utilize payment data (e.g., in database 2021) available to the operator of a payment card network, and profiling of individual cardholders, in concert with a GIS 408.

In one or more embodiments, in a first step, assign each cardholder an implied home residence. In some cases, this can be done using a known street address; for example, if a company was rolling out a program in accordance with an embodiment of the disclosure to the company's own employees. In another aspect, a cardholder can be assigned to a specific zip code based on certain inferences and/or models; this can be useful, for example, when the street address of the cardholder is not known. A non-limiting example of a situation where the street address of the cardholder is not known is the case when method steps are carried out by a payment network operator. Note that in such cases, the records in database 2021 typically do not include information allowing individual cardholders to be identified. Non limiting examples of suitable inferences or models for estimating a cardholder's zip code include determining where the cardholder's dry cleaning is done, where grocery shopping occurs for the cardholder, where the cardholder's weekend spend occurs, and where the cardholder's late evening spend occurs—all are very predictive of the zip code that the cardholder lives in. Cardholders can be assigned to geographic regions other than by zip code; zip codes are merely non-limiting examples. Thus, in one or more embodiments, for every cardholder with data in database 2021, an estimate is developed regarding where such person lives. In some cases, a record can be created in consumer database 418, with each record including some indicia of the consumer (e.g., PAN), and the inferred zip code or other inferred geographic location of the cardholder's residence.

In one or more embodiments, a further step includes inferring a destination for each cardholder of interest. In many cases, it is possible to infer that someone is working, from the variety of spending that he or she makes and the regularity of the commuting corridors that he or she follows. It may be known that certain merchants are associated with corporate food services (for example, FLIK International, a division of Compass Group North America, Charlotte, N.C., USA, is a company that runs many corporate cafeterias throughout the USA). Everyone who shops at a cafeteria at a certain address, which is run by such an entity, can be at least tentatively identified as working in that building. If the building is a limited access building, a stronger inference can be made. In at least some cases, it is also possible to identify those who go to the office every day, as opposed to sales people, who may be traveling frequently.

Next, identify all eligible locations for pick-up. In some instances, assume that a livery service in accordance with one or more embodiments would not be picking people up at their individual homes; the people are to be picked up at a publicly accessible location such as a mall, park and ride lot, train station, or some other suitable venue.

Next, assign each cardholder to one or more eligible pick-up points.

At this point, in the GIS tool 406 and associated databases, there will be present: one or more cardholders with inferred residences, a variety of eligible pick-up points, and the inferred destinations for the one or more cardholders. If desired, it is also possible to add information about the cardholder, such as total amount spent during a predetermined time period (e.g., monthly, yearly) on automobile fuel purchases (the majority of fuel sales in the US are carried out at the pump using a payment. card). In one or more embodiments, the inferred residences, pick-up points, and inferred destinations allow for identifying an ad hoc group of people who are all traveling from the same general area to the same building. For example, it is possible to identify every employee of ACME Company living within two miles (or other predetermined distance) of Anytown, Conn. and drive these individuals to the ACME headquarters in Sometown, N.Y. In one or more embodiments, group formation is accomplished using the GIS tool and database 408, 412.

Optionally, an additional step in one or more embodiments includes targeting people within the identified group(s) based on estimated receptivity to an alternative commute (for example, based on the amount of time and/or money the individuals currently spend commuting).

In some cases, identifying everyone who lives in the same zip code, has an eligible pick-up point, and is going to the same building may not yield enough passengers to fill (i.e., completely, or at least sufficiently to make the route economical) a bus, sedan, or other vehicle. In such cases, in one or more embodiments, add an additional pick-up point (say, approximately halfway to the destination) to fill the vehicle. If this still does not yield enough passengers to fill (at least enough to make the route economical) a bus, sedan, or other vehicle, consider multiple end points (i.e., multiple work locations) that are close together, as discussed further below.

Furthermore in this regard, in one or more embodiments, from a computational or algorithmic standpoint, significant complications arise if the destinations are in the same vicinity but are not the same building. Adding multiple pick-up points and/or multiple destinations, although contemplated in one or more embodiments, may harm the user experience in some instances. Thus, one or more embodiments may advantageously be employed when all the passengers are being delivered to the same destination, or very few multiple destinations.

One or more embodiments integrate payment data, residence inference, workplace inference, and a GIS system. Most GIS systems already include the ability to automatically derive routes, centralized locations, and grouping and/or clustering of data points (ESRI, POSTGIS, and R can perform these operations). One or more embodiments use pre-existing GIS software which does not currently include any payments information, and integrate same with payments information.

Furthermore with regard to integrating GIS with payments data, in one or more embodiments, look at all the transactions which have been conducted by cardholders of a certain brand of payment card. Estimate each cardholder's residential zip code, as discussed elsewhere herein, so that residential zip code is an attribute of the account number. The estimated zip code can reside, for example, in consumer database 418. It is worth noting that, in one or more embodiments, although database 418 is a “consumer database,” it will list at least one record per account owned by a consumer. A single consumer can have multiple cards and therefore appear multiple times in that database. Now, continuing, estimate each cardholder's workplace—for example, examine transactions in the time slot from approximately 10 AM to approximately 2 PM that repeatedly occur Monday-Friday but not on weekends, occur at least twice per week, and occur for more than two consecutive months. Other embodiments could examiner different time slots, different days of the week, different numbers of occurrences per week, and different numbers of consecutive time periods.

Still considering workplace estimation, in one or more embodiments, the records in database 2021 are anonymized. There is a time stamp on every transaction in database 2021. Each record also includes, in at least some embodiments, a merchant identifier, an amount, and a transaction location. It is worth noting, as an aside, that the payment method does not matter if the card-issuing bank is the entity implementing the method steps, while if the operator of a payment card network implements the method steps (e.g., VISA, MASTERCARD, AMERICAN EXPRESS, DISCOVER) then the payment brand is predetermined a priori. Using a SQL query or other database-querying technique to sort by time stamp, throw out all transactions that do not occur around lunch time during the work week. Note that in other embodiments, it is possible to search for people who work nights and weekends. As a result of the query, a pool of transactions are available which occur at mid-day, Monday through Friday. These transactions are at least somewhat predictive of where a person works. Optionally, throw out records occurring in an urban setting, since urban settings are likely to have adequate public transportation in at least some embodiments. Workplace estimation may be particularly accurate where a company or building cafeteria is present, or where there is a coffee shop or the like in the lobby or across the street that is frequented by most or all employees. In some cases, internal data in the payment card network lists merchant name and address. Thus, it can be known from data 2021 that the cardholder corresponding to a certain PAN was present at the merchant's location at the timestamp included on the transaction. In one approach, count how many transactions a given cardholder makes in a given time period at a specific merchant; every merchant with more than 40 transactions at lunch time on the same card in the same time interval is assumed to be a building cafeteria. In another approach, if more than 100 transactions a year occur, assume the merchant is a building cafeteria. In yet another approach, examine the merchant name and recognize that it is associated with corporate or building food services (e.g., FLIK example above).

Thus, in one or more embodiments, at least one attribute of a cardholder has been determined, namely, his or her residential zip code or similar indicia indicative of his or her residence. Now, identify the most commonly frequented lunchtime merchant or corporate cafeteria, and assign the address of same as the cardholder's workplace. The result is that there are two classifications of people (e.g., (1) people who live in a certain area and (2) people who work at a certain building). One or more embodiments employ an additional piece of data via the geographic information software 408, 412: enter every address for a train station, park and ride, mall, etc. in the entire continental US (or in some other country or political subdivision or in some other geographical region of interest; e.g., a predetermined radius around a workplace). Then, for each one of the cardholders where there is an inferred workplace and an inferred residence, enter same into the GIS database so that it appears as a dot on the mapping. That is to say, in one or more embodiments, there is a pinpoint for each cardholder's inferred residence and another indicia marking where he or she is heading. In some instances, larger indicia are used to designate each eligible pickup point. In some embodiments, this can be done using a buffer operation in the GIS software 408. In this operation, take a buffer around each eligible pick-up point—say, a 4-mile radius (or other appropriate predetermined radius). Employ the GIS 406, using map algebra ‘containment’ query by using a buffer operation to determine how many people are located in each buffer. Next, for the people in each buffer (i.e., close to each given pick-up point), determine how many are going to the same workplace. Using the GIS 406, look across all of the buffers and determine which pick-up points have enough people to fill a bus, sedan, helicopter, or other pertinent mode (vehicle) of pooled transportation. In one or more embodiments, this is the easiest case, where the calculations are carried out for those going directly to a single workplace.

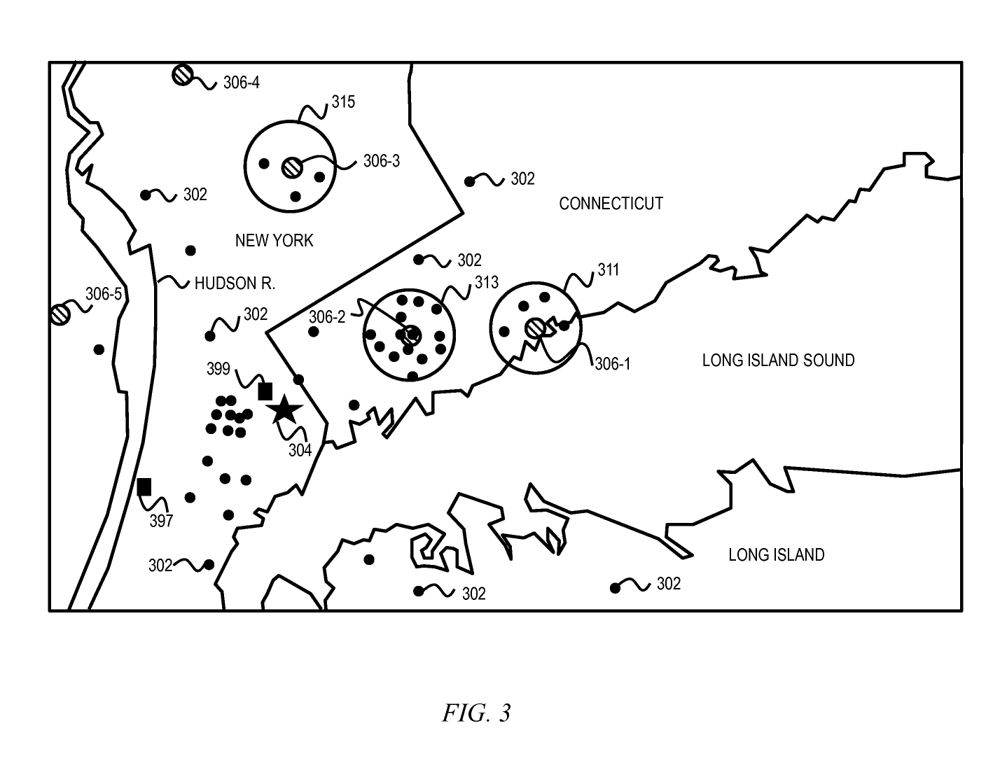

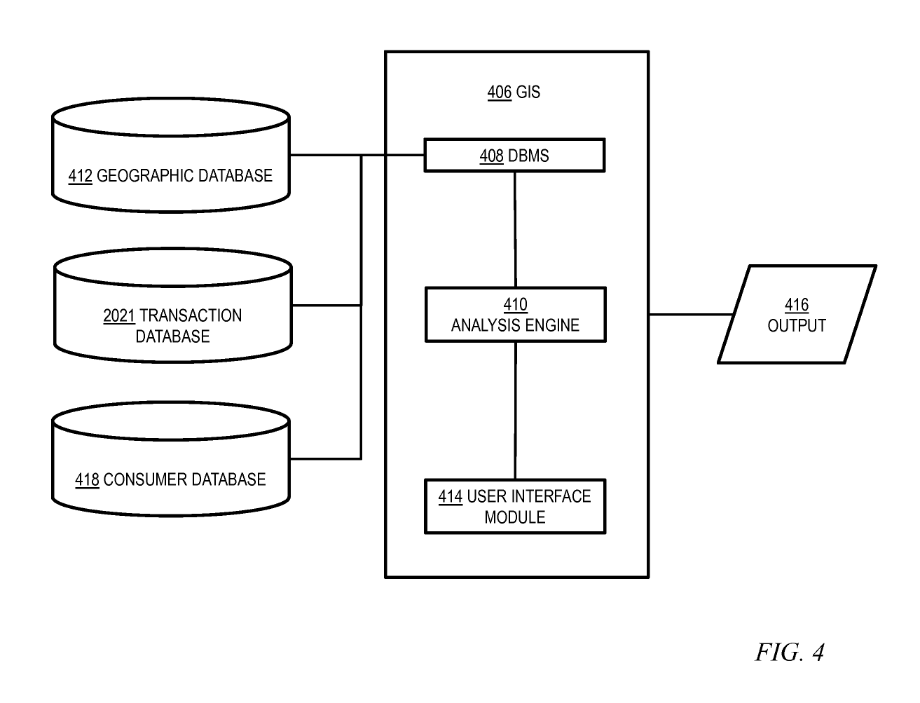

To further illustrate these points, consider FIG. 3, which is a simplified schematic map of southwest Connecticut and adjacent areas of New York. Town and city names, and roads, are omitted to avoid clutter, but could be included, if desired, on actual maps used in connection with one or more embodiments of the disclosure. Solid dots 302 represent the inferred residences of a number of cardholders. Not all dots are designated with reference characters, so as to avoid clutter. Star 304 represents the inferred work location of the cardholders represented by the dots (say, the fictional town of

“Sometown,” N.Y.). Hatched circles 306-1 through 306-5 represent potential pick-up points. Circles 311, 313, 315 of predetermined radius are located around those pick up points (306-1, 306-2, and 306-3) with sufficient close-by employees to possibly warrant transit pooling. One possible route might be from pick-up point 306-1 within circle 311 (say, near the fictional town of “Anytown,” Conn.) to the location 304.

In another aspect, consider the case where a number of people have been identified and a number of routes have already been selected (e.g., buses, vans, sedans, etc.). Seek to identify whether it is possible to pick up one or more people en route if one of the identified routes happens to be driving past a house or pick-up point, and such one or more people were traveling to the same location. GIS software already includes the ability to perform route optimization—it can suggest what route to take from address A to address B. Some embodiments use the GIS to forecast or model how many people a bus or other mode of transportation could pick up en route to a given work place. So, if there are not enough participants for a route from the pick-up point 306-1 within circle 311 to the location 304, cardholders living near an intermediate point (say, the pick-up point 306-2 within circle 313, possibly near the fictional town of “Middleville,” Conn.) can be contacted.

In still another aspect, suppose there are at least some pick-up points that do not have enough people to fill a bus (or other mode of transportation) going to a specific work place, even with additional pick-ups en route. In such cases, in some instances, examine multiple work places in the vicinity of each other. In a non-limiting exemplary embodiment, for all work places identified from the payment data, identify the distance between each pair of work places. Starting from the minimum distance pair, which will probably be buildings across the street from each other or next to each other, explore whether a bus (or other pertinent mode of transportation), going to those two destinations, could be filled (with or without additional pick-ups en route). Once the minimum distance pair has been tried, if needed, examine the next minimum distance pair, until enough people to justify a bus (or other pertinent mode of transportation) have been identified. Here, pairing of workplaces 304 and 399 would be attempted before pairing of workplaces 304, 397. As noted above, star 304 represents the inferred work location of the cardholders represented by the dots (say, the fictional town of “Sometown,” N.Y.). Workplaces 397 and 399 are represented as rectangles rather than stars since, although they are also workplaces, they do not correspond to the inferred work location of the cardholders represented by the dots.

In another aspect, pooled transportation vehicle choice can be targeted based on implied affordability to the cardholder, which can be determined using a variety of techniques.

It is worth noting that in one or more embodiments, steps can be carried out by an entity such as the operator of a payment card network (e.g., MasterCard International Incorporated, Purchase, N.Y., USA). Normally, the issuing bank, rather than the operator of the payment card network, has the cardholder's personal information, in which case, the operator of the payment card network cannot communicate with the cardholder unless the cardholder registers with the operator of the payment card network. Accordingly, one or more embodiments are provided as an opt-in system, with cardholder consent, or as a marketing service provided to issuing banks (payment card network operator advises card issuer of PANs identified as candidates for transit routes and issuer can determine who the actual cardholders are).

By way of review and provision of additional detail, consider that many commuters drive hours every day because mass transit is not a viable alternative for them. One or more embodiments provide techniques for “mass transit customization” to identify a predetermined number of people (forty in a non-limiting example) that travel from roughly the same origin to the same destination daily, and offer them a customized bus or van route or the like, thereby saving them costs associated with tolls, motor fuel, auto wear and tear, and stress while giving them back additional time that can be used to sleep or work.

In a non-limiting example, a cardholder's residential zip code can be inferred, in at least some cases, using methods disclosed in unpublished U.S. patent application Ser. No. 13/721,216 of first named inventor Curtis Villars, filed Dec. 20, 2012 and entitled METHOD AND SYSTEM FOR ASSIGNING SPENDING BEHAVIORS TO GEOGRAPHIC AREAS. The Villars reference is hereby expressly incorporated by reference herein in its entirety for all purposes and pertinent portions are reproduced below (figure and reference characters are changed as needed to avoid confusion with those of the present disclosure). Furthermore in this regard, residential zip code can be inferred by the centroid of transactions likely to be carried out near home; work zip code can be inferred by the centroid of transactions likely to be carried out near work. Zip code is a non-limiting example of a postal code or other similar geographic indicia. A cardholder's residence zip code (or other indicia of his or her residence location) can be estimated using other suitable techniques in other embodiments. Whether a cardholder is employed can be estimated from spending patterns on the card. The patterns of card spending (such as lunch time spending during the workweek) are also examined, to estimate whether the cardholder works at a fixed location or at a location that changes frequently. If the cardholder works at a fixed location, then lunchtime spending can be used to estimate the geography where the cardholder works. It is helpful, but not necessary, if there is a company or building cafeteria, which helps to rapidly identify all employees in the given building.

As alluded to above, in some instances, further investigation can be performed to determine an individual cardholder's receptivity to a pooled transportation mode. For example, estimate the distance commuted every day by a cardholder, using the inferred residence and workplace information. For a given payment card account, all motor fuel purchase transactions are summed to estimate the annualized fuel expense. The overall spending on the card and the variety of purchase categories are used to estimate the cardholder's income. For example, consider overall spending: someone who spends $100,000 on a credit card is most likely in a different income bracket than someone who spends $10,000 and would likely want different types of service. Consider also purchase variety: for example, someone who spends $25,000 per year but who only uses his or her card on vacation likely makes much more than someone who spends $25,000 in every purchase category (vacation, apparel, grocery, insurance, telecom, etc.). In a basic, or “capacity filling groups,” approach, identify groups of cardholders who live more than a threshold distance ‘L’ from the inferred workplace, out to a maximum distance ‘D’ from the inferred workplace (for example, the furthest distance that any employee who works at the inferred workplace lives from the inferred workplace) and within a threshold radius ‘R’ of a pickup point with adequate parking space (e.g., so-called Park & Ride lots, malls, or railroad stations), and who that are traveling to the same building. In a non-limiting example, ‘L’ is selected by experience based on a commuting time below which it is not believed that people will be interested in pooling. In some cases, this value may be 20-30 minutes; other situations may be different. In some cases, an iterative approach is employed with applicable state-of-the-art optimization methods to determine an optimal filling solution. In some cases, iteration is carried out using discrete values of ‘R’; purely by way of example and not limitation, 1 mile (1.6 km), 2 miles (3.2 km), 5 miles (8.0 km), and 10 miles (16.1 km). In some cases, ‘R’ is allowed to vary as a percentage of D.

For all groups traveling from the same origin to the same destination, send offers to the first forty respondents to purchase monthly subscriptions to the customized transit service. Please note, forty is a non-limiting example based on a bus route with busses having an economical loading of forty persons; similar techniques can alternatively be applied to smaller audiences for van, sedan, helicopter, or other services. In one or more embodiments, estimate the cardholder's residence and workplace locations using GIS software to plot purchases likely to be made near home and at work for each cardholder. Create a buffer of radius ‘R’ around each eligible pickup point. For each destination identify all pickup points with more cardholders than the number required to make the trip economical.

In a “route optimization for single destination” approach, where there are pickup points with too few cardholders to merit a bus (or other vehicle under consideration), all other pickup points with individuals traveling to the same building, which are on the travel route from a given pickup point with too few cardholders, should be presented with the subscription offer.

In a “non-capacity filling groups” approach, after all groups have been created from the capacity filling groups approach and the route optimization for single destination approach, groups that are traveling to nearby destinations from the same pickup point(s) can be combined. In this case, effort is taken to minimize the number of destinations and their proximity.

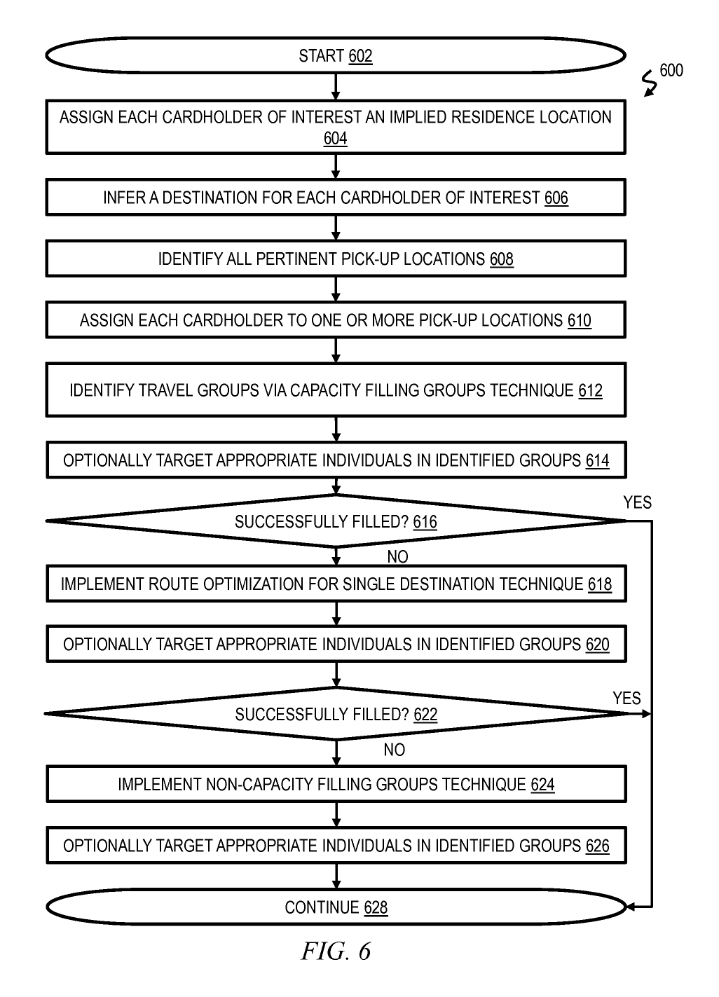

Given the discussion thus far, and with reference to the flow chart 600 of FIG. 6, which begins at 602, it will be appreciated that, in general terms, an exemplary method includes step 604, namely, using payment card transaction data, estimating residence locations for a plurality of payment card holders; and step 606, namely, using payment card transaction data, estimating recurrent destinations for at least a first portion of the plurality of payment card holders. Further steps include step 608, identifying a plurality of pooled transit pick-up points in a geographic region of interest; and step 610, assigning each of at least a second portion of the payment card holders to at least one of the pooled transit pick-up points. Note that the first portion could include some or all of the plurality of payment card holders, and the second portion could include some or all of the first portion. Note that people do not necessarily need to be assigned to pick-up points very close to where they live. For example, if someone lives two hours from his or her office, he or she may still be an enthusiastic customer of utilizing a bus or other vehicle for half of that distance. An even further step 612 includes identifying at least some of the payment card holders assigned to at least one of the pick-up points as potential riders of a pooled transit service. In some cases, an attempt is made to completely fill the pooled transit vehicle. In some cases, an attempt is made to obtain at least an economically viable number of passengers for the pooled transit vehicle; i.e., a number of passengers sufficient for it to make economic sense for the provider of the pooled transit service to undertake to provide the service.

In some cases, a further step includes offering the pooled transit service to at least some of the payment card holders assigned to the at least one of the pick-up points. Note that in the most general case, all, or a subset, of the identified card holders could be offered the service. For example, in some cases, in the offering step, the offering includes offering the pooled transit service to less than all of the payment card holders assigned to the at least one of the pick-up points, and a further step 614 includes targeting a subset of all of the payment card holders assigned to the at least one of the pick-up points to receive the offering.

Such targeting can be based, for example, on at least one of estimated current commuting time and estimated current commuting expense, and/or on affordability.

In some cases, for at least one of the pooled transit pick-up points not having sufficient interested cardholders to justify the pooled transit service, carry out the additional steps of examining a route, from the at least one of the pooled transit pick-up points not having sufficient interested cardholders, to a common recurring destination, for at least one other of the pooled transit pick-up points located close to the route (see steps 616, 618); and offering the pooled transit service to at least some of the payment card holders assigned to the at least one other of the pooled transit pick-up points located close to the route. See discussion of pick-up points 306-1 and 306-2 in connection with FIG. 3.

Furthermore with regard to steps 616 and 618, in step 616, determine whether the group(s) were successfully filled in the capacity filling groups technique; if not, implement the route optimization for a single destination technique.

Optional targeting step 620, similar to step 614, can be carried out if appropriate.

In some cases, which may or may not involve first undertaking route optimization, an additional step includes, for at least one of the pooled transit pick-up points not having sufficient interested cardholders to justify the pooled transit service (in the case of doing route optimization first, even after offering the pooled transit service to those payment card holders assigned to the at least one other of the pooled transit pick-up points (e.g., 306-2) located close to the route), combining the route with another route to another recurring destination, close to but different from the common recurring destination(see steps 622, 624, and discussion of second workplace 399 in connection with FIG. 3).

In some such cases, the combining is carried out by searching routes to recurring destinations other than the common recurring destination in order from closest (e.g., 399) to furthest (e.g., 397) until there are sufficient interested cardholders to justify the pooled transit service.

Furthermore with regard to steps 620 and 624, in step 620, optionally determine whether the group(s) were successfully filled in the route optimization for a single destination technique; if not, implement the non-capacity filling groups technique.

Optional targeting step 626, similar to steps 614 and 620, can be carried out if appropriate.

Processing continues at 628.

In general, the method steps of FIG. 6 can be carried out using the system of FIG. 4. In some cases, the step 604 of estimating the residence locations for the plurality of payment card holders using the payment card transaction data includes taking a geocentroid of evening and weekend purchases of domestic-related items. In some cases, the step 606 of estimating the recurring destinations for the plurality of payment card holders using the payment card transaction data includes identifying at least one frequent mid-week-day spending location. In some cases, step 610 includes conducting a buffer operation with geographic information system 406.

In a non-limiting example, steps 604 and 606 are carried out with DBMS 408 querying databases 412, 418, 2021, and optionally with needed analysis from engine 410. Steps 608-612, 618, 624 are carried out with DBMS 408 querying database 412, 418 and optionally with needed analysis from engine 410. Decision blocks 616, 622 can be implemented, for example, with logic (e.g., in engine 410). Steps 614, 620 and 626 are carried out with DBMS 408 querying database 412 (and optionally 418), and optionally with needed analysis from engine 410. In some instances, the functionality of two or more of the databases could be merged.

### System and Article of Manufacture Details

Embodiments of the disclosure can employ hardware and/or hardware and software aspects. Software includes but is not limited to firmware, resident software, microcode, etc. Software might be employed, for example, in connection with one or more of queries to databases 412, 418, 2021; elements 408, 410, 414 of suite 406; a terminal 122, 124, 125, 126; a reader 132; a host, server, and/or processing center 140, 142, 144 (optionally with data warehouse 154) of a merchant, issuer, acquirer, processor, or operator of a network 2008, operating according to a payment system standard (and/or specification); and the like. Firmware might be employed, for example, in connection with payment devices such as cards 102, 112, as well as reader 132.

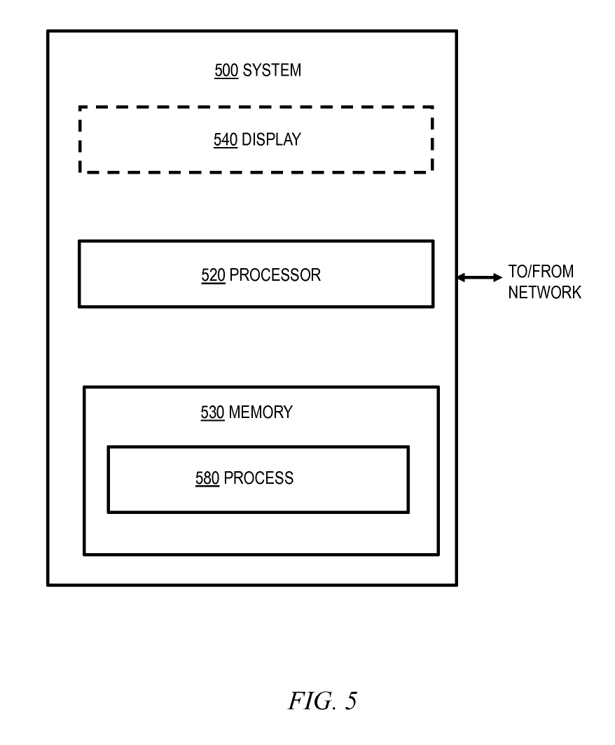

FIG. 5 is a block diagram of a system 500 that can implement part or all of one or more aspects or processes of the disclosure. As shown in FIG. 5, memory 530 configures the processor 520 (which could correspond, e.g., to processor portions 106, 116, 130; a processor of a terminal or a reader 132; processors of remote hosts in centers 140, 142, 144; processors of hosts and/or servers implementing various functionality such as that for querying databases 412, 418, 2021; and the like); to implement one or more aspects of the methods, steps, and functions disclosed herein (collectively, shown as process 580 in FIG. 5). Different method steps can be performed by different processors. The memory 530 could be distributed or local and the processor 520 could be distributed or singular. The memory 530 could be implemented as an electrical, magnetic or optical memory, or any combination of these or other types of storage devices (including memory portions as described above with respect to cards 102, 112). It should be noted that if distributed processors are employed, each distributed processor that makes up processor 520 generally contains its own addressable memory space. It should also be noted that some or all of computer system 500 can be incorporated into an application-specific or general-use integrated circuit. For example, one or more method steps could be implemented in hardware in an ASIC rather than using firmware. Display 540 is representative of a variety of possible input/output devices (e.g., displays, printers, keyboards, mice, touch pads, and so on).

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a computer system, to carry out all or some of the steps to perform the methods or create the apparatuses discussed herein. A computer-usable medium may, in general, be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk. The medium can be distributed on multiple physical devices (or over multiple networks). For example, one device could be a physical memory media associated with a terminal and another device could be a physical memory media associated with a processing center. As used herein, a tangible computer-readable recordable storage medium is defined to encompass a recordable medium (non-transitory storage), examples of which are set forth above, but does not encompass a transmission medium or disembodied signal.

The computer systems and servers described herein each contain a memory that will configure associated processors to implement the methods, steps, and functions disclosed herein. Such methods, steps, and functions can be carried out, by way of example and not limitation, by processing capability on one, some, or all of elements 122, 124, 125, 126, 140, 142, 144, 2004, 2006, 2008, 2010; on a computer implementing part or all of suite 406 and/or interacting with databases 412, 418, 2021; and the like. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the disclosure, such as, for example, 122, 124, 125, 126, 140, 142, 144, 2004, 2006, 2008, 2010; a computer implementing part or all of suite 406 and/or interacting with databases 412, 418, 2021; and the like, can make use of computer technology with appropriate instructions to implement method steps described herein. Some aspects can be implemented, for example, using one or more servers which include a memory and at least one processor coupled to the memory. The memory could load appropriate software. The processor can be operative to perform one or more method steps described herein or otherwise facilitate their performance.

Accordingly, it will be appreciated that one or more embodiments of the disclosure can include a computer program comprising computer program code means adapted to perform one or all of the steps of any methods or claims set forth herein when such program is run on a computer, and that such program may be embodied on a computer readable medium. Further, one or more embodiments of the present disclosure can include a computer comprising code adapted to cause the computer to carry out one or more steps of methods or claims set forth herein, together with one or more apparatus elements or features as depicted and described herein.

As used herein, including the claims, a “server” includes a physical data processing system (for example, system 500 as shown in FIG. 5) running a server program. It will be understood that such a physical server may or may not include a display, keyboard, or other input/output components. A “host” includes a physical data processing system (for example, system 500 as shown in FIG. 5) running an appropriate program.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components shown in the figures. In one or more embodiments, the modules include a DBMS module to implement DBMS 408, an analysis engine module to implement analysis engine 410, and a user interface module 414; these three modules in turn implement GIS 406. In one or more embodiments, a geographic database 412, transaction database 2021, and consumer database 418 are stored in a persistent (non-transitory) storage medium; a hard disk drive is a non-limiting example. These databases are accessed by the DBMS 408. The method steps can then be carried out using the distinct software modules of the system, as described above, executing on the one or more hardware processors. Further, a computer program product can include a tangible computer-readable recordable storage medium with code adapted to be executed to carry out one or more method steps described herein, including the provision of the system with the distinct software modules.

Thus, aspects of the disclosure can be implemented, for example, by one or more appropriately programmed general purpose computers, such as, for example, servers or personal computers, located at one or more of the entities in the figures, as well as within the payment network 2008, implementing, for example, suite 406 or portions thereof. Such computers can be interconnected, for example, by one or more of payment network 2008, another VPN, the Internet, a local area and/or wide area network (LAN and/or WAN), via an EDI layer, and so on. Note that element 2008 represents both the network and its operator. The computers can be programmed, for example, in compiled, interpreted, object-oriented, assembly, and/or machine languages, for example, one or more of C, C++, Java, Visual Basic, COBOL, Assembler, Structured Query Language (SQL), and the like (an exemplary and non-limiting list), and can also make use of, for example, Extensible Markup Language (XML), known application programs such as relational database applications (e.g., IBM DB2®, software available from International Business Machines Corporation, Armonk, N.Y., US; SAS® software available from SAS Institute, Inc., Cary, N.C., US), spreadsheets (e.g., MICROSOFT EXCEL® software available from Microsoft Corporation, Redmond, Wash., US), and the like. The computers can be programmed to implement the logic and/or data flow depicted in the figures. In some instances, messaging and the like may be in accordance with the International Organization for Standardization (ISO) Specification 5583 Financial transaction card originated messages—Interchange message specifications and/or the ISO 20022 or UNIFI Standard for Financial Services Messaging, also incorporated herein by reference in its entirety for all purposes. In some instances, some messages may be in accordance with NACHA Automated Clearing House (ACH) rules and regulations.

Although illustrative embodiments of the disclosure have been described herein with reference to the accompanying drawings, it is to be understood that the disclosure is not limited to those precise embodiments, and that various other changes and modifications may be made by one skilled in the art without departing from the scope or spirit of the disclosure.

Reproduction of Certain Portions of U.S. patent application Ser. No. 13/721,216 of first named inventor Curtis Villars, filed Dec. 20, 2012 and entitled METHOD AND SYSTEM FOR ASSIGNING SPENDING BEHAVIORS TO GEOGRAPHIC AREAS [PLEASE IGNORE—NEEDED FOR LEGAL REASONS].

The present disclosure provides a description of a system and method for assigning spending behaviors to geographic areas.

A method for identifying spending behaviors in a geographic area includes: storing, in a database, a plurality of geographic centroids, wherein each geographic centroid corresponds to a centroid of a predefined geographic area; receiving, by a receiving device, a plurality of financial transactions involving each consumer of a plurality of consumers; identifying, by a processing device, a geographic location of each financial transaction of the plurality of financial transactions; calculating, for each consumer of the plurality of consumers, a purchase centroid of the financial transactions involving the consumer based on a centroid of the identified geographic location of each of the financial transactions involving the consumer; analyzing, for each consumer, spending behaviors based on the financial transactions involving the consumer; associating the analyzed spending behavior for each consumer with the corresponding purchase centroid; associating, in the database, the analyzed spending behaviors for each purchase centroid with a predetermined number of geographic centroids based on the distance from the purchase centroid to each of the predetermined number of geographic centroids; and aggregating, in the database, each of the spending behaviors associated with each geographic centroid of the plurality of geographic centroids such that each corresponding geographic area is associated with aggregated spending behaviors.

A system for identifying spending behaviors in a geographic area includes a database, a receiving device, and a processing device. The database is configured to store a plurality of geographic centroids, wherein each geographic centroid corresponds to a centroid of a predefined geographic area. The receiving device is configured to receive a plurality of financial transactions involving each consumer of a plurality of consumers. The processing device is configured to: identify a geographic location of each financial transaction of the plurality of financial transactions; calculate, for each consumer of the plurality of consumers, a purchase centroid of the financial transactions involving the consumer based on a centroid of the identified geographic location of each of the financial transactions involving the consumer; analyze, for each consumer, spending behaviors based on the financial transactions involving the consumer; associating the analyzed spending behavior for each consumer with the corresponding purchase centroid; associate, in the database, the analyzed spending behaviors for each purchase centroid with a predetermined number of geographic centroids based on the distance from the purchase centroid to each of the predetermined number of geographic centroids; and aggregate, in the database, each of the spending behaviors associated with each geographic centroid of the plurality of geographic centroids such that each corresponding geographic area is associated with aggregated spending behaviors.

### System for Assigning Spend Behaviors to Geographic Areas

FIG. 6 illustrates a system 1100 for assigning consumer spend behaviors to a plurality of geographic areas based on purchase and geographic centroids. Several of the components of the system 1100 may communicate via a network 1116. The network 1116 may be any network suitable for performing the functions as disclosed herein and may include a local area network (LAN), a wide area network (WAN), a wireless network (e.g., Wi Fi), a mobile communication network, a satellite network, the Internet, fiber optic, coaxial cable, infrared, radio frequency (RF), or any combination thereof. Other suitable network types and configurations will be apparent to persons having skill in the relevant art.

The system 1100 may be used by a consumer 1102 who engages in a financial transaction with a merchant 1104. The financial transaction may be an in-person financial transaction (e.g., at a physical location of the merchant 1104) or may be performed remotely, such as via telephone, mail, or the Internet (e.g., “card not present” transactions). The financial transaction may be processed by a financial transaction processing agency 1106. The financial transaction processing agency 1106 may use any type of processing system configured to process financial transactions as part of a traditional four-party transaction processing system as apparent to persons having skill in the relevant art, such as MasterCard® or VISA®.

For example, the merchant 1104 may submit transaction details for the financial transaction to an acquiring bank, which may submit an authorization request to the financial transaction processing agency 1106. The financial transaction processing agency 1106 may contact an issuing bank that has issued a payment card used in the transaction to the consumer 1102 for approval of the transaction, which may subsequently be forwarded on to the acquiring bank and/or the merchant 1104. The financial transaction processing agency 1106 may identify and store transaction information for each financial transaction processed. Transaction information may include, for example, payment method, transaction amount, merchant identification, transaction location, merchant industry, transaction time and date, etc.

The merchant 1104 may have a desire to advertise to consumers, such as the consumer 1102, that have a frequency of transacting in the geographic area of a physical location of the merchant 1104. In order to identify these consumers, the merchant 1104 may submit a request to a processing server 1108. The processing server 1108, as discussed in more detail below, may receive transaction information from the financial transaction processing agency 1106 and store the received information in a transaction database 1112. In an exemplary embodiment, the transaction information received and stored in the transaction database 1112 may not include any personally identifiable information. In one embodiment, the processing server 1108 and the financial transaction processing agency 1106 may be a single entity.

The processing server 1108 may also include a geographic database 1110, configured to store geographic areas and their associated geographic centroids, as discussed in more detail below. The processing server 1108 may be configured to identify purchase centroids for consumers, by methods as discussed herein and apparent to persons having skill in the relevant art, based on associated transaction information stored in the transaction database 1112. The processing server 1108 may also be configured to analyze spend behaviors for consumers (e.g., the consumer 1102) based on the transaction information. The processing server 1108 may be further configured to identify a predetermined number of geographic centroids based on the distance from a purchase centroid to the corresponding geographic centroids, and associate the analyzed spend behaviors with the identified geographic areas. The corresponding data may be aggregated and used in order to identify consumers to respond to the request of the merchant 1104.

### Processing Server

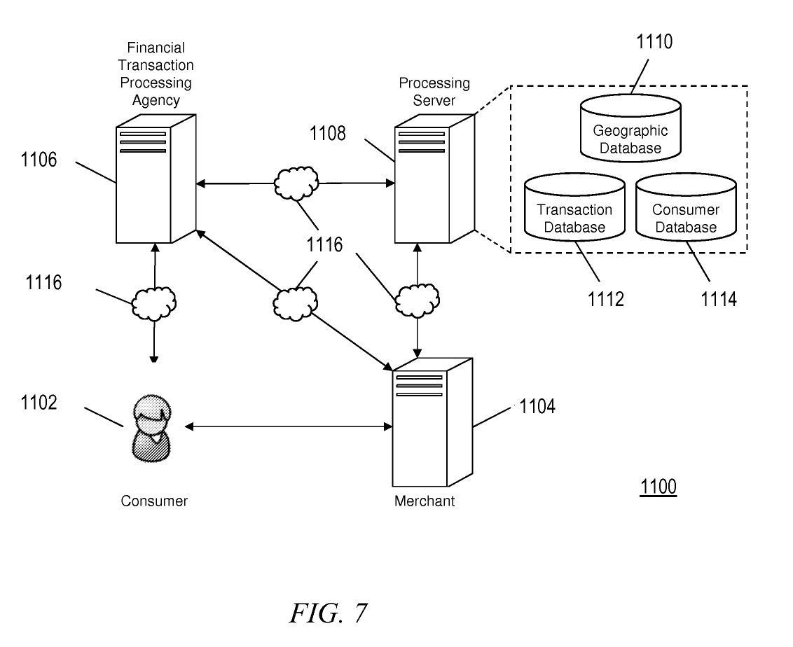

FIG. 7 illustrates an embodiment of the processing server 1108. The processing server 1108 may be any kind of server configured to perform the functions as disclosed herein, such as the computer system illustrated in FIG. 5 and described in more detail elsewhere herein. The processing server 1108 may include the geographic database 1110, the transaction database 1112, a consumer database 1114, a receiving unit 1202, a processing unit 1204, a calculating unit 1206, and a transmitting unit 1208. Each of the components may be connected via a bus 1210. Suitable types and configurations of the bus 1210 will be apparent to persons having skill in the relevant art.

Data stored in the geographic database 1110, the transaction database 1112, and the consumer database 1114 (the “databases”) may be stored on any type of suitable computer readable media, such as optical storage (e.g., a compact disc, digital versatile disc, blu-ray disc, etc.) or magnetic tape storage (e.g., a hard disk drive). The databases may be configured in any type of suitable database configuration, such as a relational database, a structured query language (SOL) database, a distributed database, an object database, etc. Suitable configurations and database storage types will be apparent to persons having skill in the relevant art. The databases may each be a single database, or may comprise multiple databases which may be interfaced together (e.g., physically or via a network, such as the network 1116).

The geographic database 1110, as discussed in more detail below, may be configured to store information regarding a plurality of geographic areas and corresponding geographic centroids. A geographic centroid may be a centroid of the corresponding geographic area as identified and/or calculated (e.g., by the calculating unit 1206) by the processing server 1108. Methods for calculating or identifying the centroid of an area will be apparent to persons having skill in the relevant art and may include a plumb line or balancing method, geometric decomposition, integral formula, etc.

The transaction database 1112 may be configured to store transaction information corresponding to a plurality of financial transactions including a plurality of consumers. In an exemplary embodiment, the transaction information may contain no personally identifiable information. The transaction information may include any information suitable for performing the functions as disclosed herein, such as transaction location, merchant identification, transaction time and/or date, transaction amount, payment method, etc. The consumer database 1114 may be configured to store consumer profile information for a plurality of consumers as discussed in more detail below.

The receiving unit 1202 may be configured to receive transaction information for a plurality of transactions, which may be stored (e.g., via the processing unit 1204) in the transaction database 1112. In embodiments where the processing server 1108 may also operate as the financial transaction processing agency 1106, the receiving unit 1202 may be further configured to receive authorization requests for financial transactions. The receiving unit 1202 may also be configured to receive requests from merchants (e.g., the merchant 1104) for spending behaviors in at least one geographic area.

The processing unit 1204 may be configured to identify a geographic location of each financial transaction stored in the transaction database 1112. In one embodiment, the geographic location may be directly included in the transaction information. In another embodiment, the processing unit 1204 may identify a geographic location associated with the merchant included in the financial transaction (e.g., by utilizing a lookup table of geographic locations and merchant identification numbers). Other methods for identifying geographic locations of financial transactions will be apparent to persons having skill in the relevant art, such as receiving the geographic location from a mobile communication device used in the financial transaction (e.g., for payment via an electronic wallet).

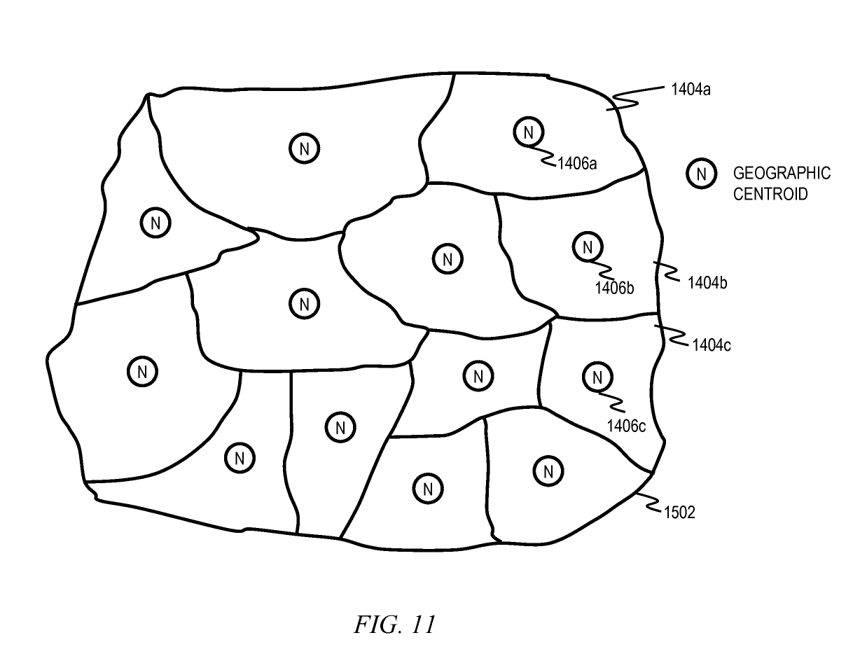

The calculating unit 1206 may be configured to calculate a purchase centroid for each consumer based on the identified geographic locations of the financial transactions included the respective consumer, as discussed in more detail below with respect to FIG. 11. The processing unit 1204 may be configured to store the calculated purchase centroid in the consumer database 1114 in a consumer data entry corresponding to the associated consumer.

The processing unit 1204 may be further configured to analyze, for each consumer, spending behaviors based on the financial transactions including the consumer and stored in the transaction database 1112. Spending behaviors may include, for example, propensity to spend, propensity to spend in a particular industry, propensity to spend at a particular merchant, transaction frequency, transaction frequency in a particular industry or at a particular merchant, regular spend amount, regular spend amount in a particular industry or at a particular merchant, propensity to spend at specific dates and/or times, and other behaviors as will be apparent to persons having skill in the relevant art. The processing unit 1204 may then associate the analyzed spending behaviors to the consumer's corresponding purchase centroid.

The processing unit 1204 (e.g., or the calculating unit 1206) may be further configured to identify a predetermined number of geographic areas based on the distance from a purchase centroid to the corresponding geographic centroid, and associate the corresponding spend behaviors to the geographic area. It will be apparent to persons having skill in the relevant art that the predetermined number of geographic areas may vary from application to application. For example, in some industries where consumers are less likely to commute a long distance to transact, such as grocery shopping, the predetermined number may be based on a particular distance (e.g., 5 miles for a rural region). In industries where consumers are more likely to commute, such as for specialty items, the predetermined number may be based on a further distance (e.g., 25 miles). In some instances, the predetermined number of geographic areas may be an integer number, such as the five closest geographic areas.

The processing unit 1204 may also be configured to aggregate the spending behaviors associated with a geographic area in order to identify an overall (e.g., average) spending behavior for consumers that regularly transact in or near the geographic area.

The transmitting unit 1208 may be configured to transmit the aggregated spending behaviors to the merchant 1104, such as in response to a request for spending behaviors. The aggregated spending behaviors may be for the geographic area including the merchant 1104, or the geographic area may be selected based on the corresponding spending behaviors. For example, the merchant 1104 may request the geographic area for all consumers with a specified propensity to spend in its respective industry, so that the merchant 1104 can advertise to the consumers in that geographic area.

### Consumer and Geographic Databases

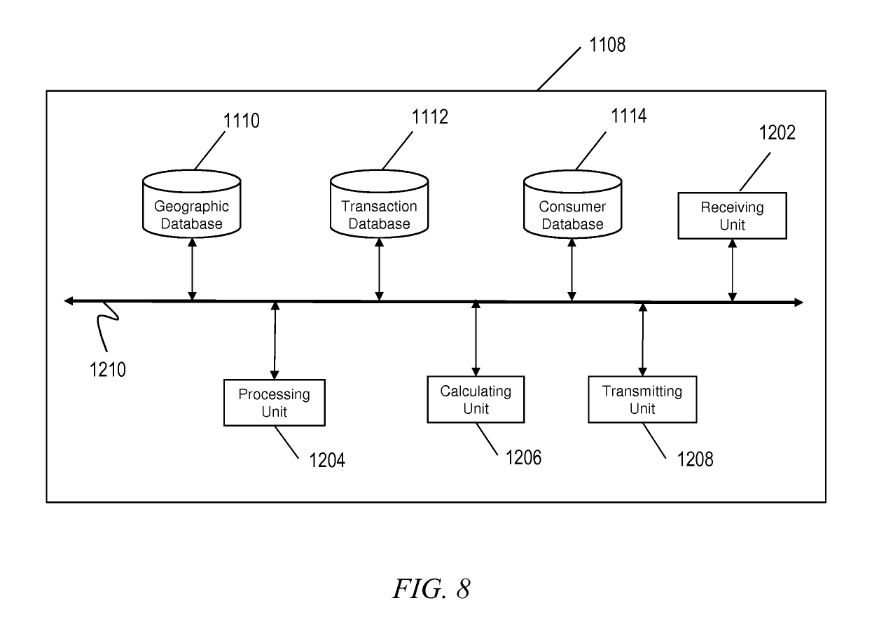

FIG. 8 illustrates the consumer database 1114 of the processing server 1108. The consumer database 1114 may include a plurality of consumer data entries 1302, illustrated as consumer data entries 1302a, 1302b, and 1302c. Each consumer data entry 1302 may include at least a consumer identifier 1304, a purchase centroid 1306, spending behaviors 1308, and associated geographic centroids 1310. It will be apparent to persons having skill in the relevant art that the associated geographic centroids 1310 may be optional (e.g., and alternatively stored in the geographic database 1110).

The consumer identifier 1304 may be a unique value associated with a consumer (e.g., the consumer 1102) for identification of the consumer. In one embodiment, the consumer identifier 1304 may be an account number, such as for a payment card account. In another embodiment, the consumer identifier 1304 may be a unique value identified and/or generated by the processing server 1108 (e.g., via the processing unit 1204). The consumer identifier 1304 may be used in order to associate the consumer 1102 with the financial transactions including the consumer 1102 stored in the transaction database 1112.

The purchase centroid 1306 may be a purchase centroid associated with the consumer 1102 based on the geographic location of financial transactions including the consumer 1102, as described in more detail below. In an exemplary embodiment, the purchase centroid 1306 may be a geographic location represented using latitude and longitude. The spending behaviors 1308 may be spending behaviors associated with the consumer 1102 based on analysis of financial transactions including the consumer 1102 and stored in the transaction database 1112. Behaviors included in the spending behaviors 1308 may include propensity to spend, propensity to spend in a particular industry, etc. as discussed above.

The associated geographic centroids 1310 may include geographic centroids (e.g., or their corresponding geographic areas) for which the consumer's purchase centroid 1306 is associated. In some embodiments, the associated geographic centroids 1310 may only include a single geographic centroid (e.g., the closest geographic centroid to the purchase centroid 1306). In other embodiments, the number of geographic centroids included in the associated geographic centroids 1310 may be based on a variety of factors, such as requested number of areas, spending behaviors, geographic area selection, etc.

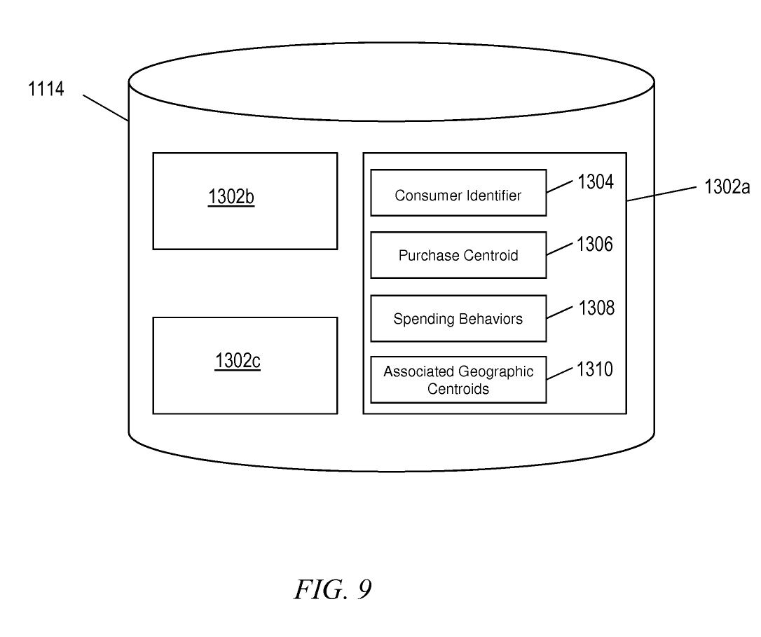

FIG. 9 is an illustration of the geographic database 1110 of the processing server 1108. The geographic database 1110 may include a plurality of geographic data entries 1402, illustrated as geographic data entries 1402a, 1402b, and 1402c. Each geographic data entry 1402 may include a geographic area 1404, a geographic centroid 1406, associated purchase centroids 1408, and aggregated spending behaviors 1410. Additional information that may be included in the geographic database 1110 will be apparent to persons having skill in the relevant art.

The geographic area 1404 may be any geographic area for which spending behaviors may be aggregated. For example, the geographic area 1404 may be a zip code or postal code, a county, a municipality, a shopping district, shopping center, or any other defined geographic area as will be apparent to persons having skill in the relevant art. In an exemplary embodiment, the geographic area 1404 may be defined using latitude and longitude. The geographic centroid 1406 may be the calculated or identified centroid of the geographic area 1404. Methods used for calculating or identifying the geographic centroid of an area will be apparent to persons having skill in the relevant art.

The associated purchase centroids 1408 may include all purchase centroids (e.g., or consumer data entries 1302 including the respective purchase centroids) associated with the geographic area 1404 as discussed herein. The aggregated spending behaviors 1410 may include an aggregation of spending behaviors for each of the consumer data entries 1302 corresponding to each purchase centroid 1306 in the associated purchase centroids 1408. As such, the aggregated spending behaviors 1410 may be a representation of the spending behavior of consumers that regularly transact in or near the geographic area 1404.

### Geographic and Purchase Centroids

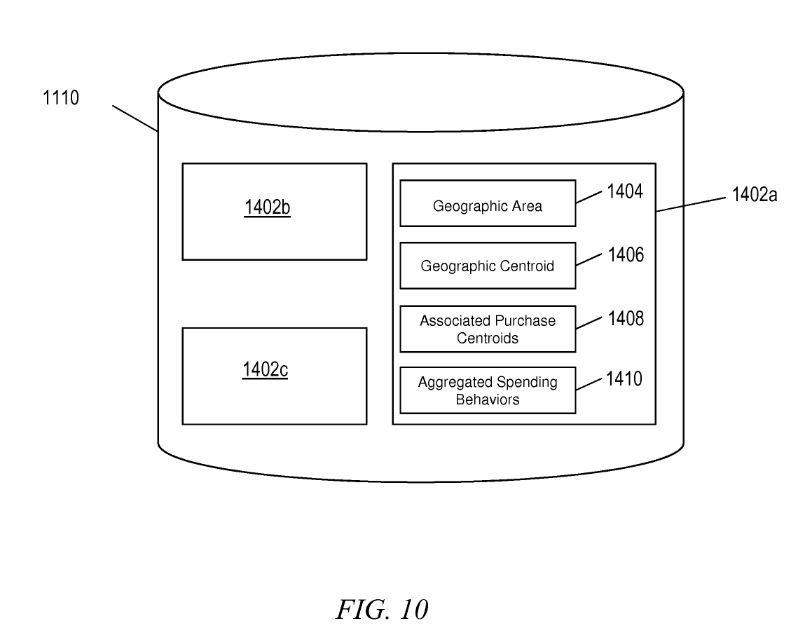

FIG. 10 is an illustration of an area 1502 that includes a plurality of geographic areas 1404, illustrated as geographic area 1404a, 1404b, and 1404c. As discussed previously, each geographic area 1404 may have a corresponding geographic centroid 1406. The geographic centroid 1406 may be the centroid, or the geometric center, of the corresponding geographic area 1404. As illustrated in FIG. 10, geographic areas 1404a, 1404b, and 1404c each include a corresponding geographic centroid 1406a, 1406b, and 1406c, respectively.

FIG. 11 is an illustration of the area 1502 as displaying a plurality of financial transactions 1602. The plurality of financial transactions 1602 may include those financial transactions that include a specific consumer 1102, such as based on the associated consumer identifier 1304. The financial transactions 1602 may be displayed based on their geographic location, which may be utilized using methods as discussed herein in order to calculate or identify the purchase centroid 1306 corresponding to the financial transactions.

In some embodiments, the financial transactions 1602 may include weighted financial transactions, such as the weighted transactions 1604. Weighted transactions may be financial transactions that have greater weight when calculating or identifying the purchase centroid 1306. A transaction may have a greater weight depending on the circumstances and application. For example, transactions may be weighted based on the transaction amount, such that large transactions are considered more heavily than smaller transactions for the calculation of the purchase centroid 1306. Similarly, if spending behaviors are analyzed for a particular industry, financial transactions that include a merchant within that industry may be viewed as weighted transactions 1604. In some instances, all of the financial transactions 1602 may include only those transactions of a specific industry. Other considerations for the weighting of financial transactions will be apparent to persons having skill in the relevant art, such as time of day, day of the week, season (e.g., summer spending as opposed to winter spending), etc.

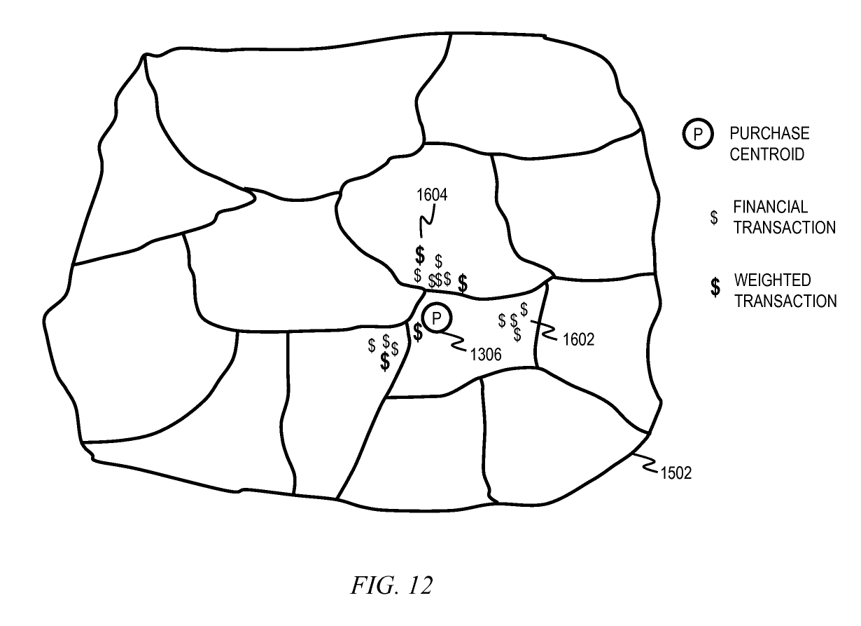

FIG. 12 illustrates the area 1502 and the identification of geographic centroids 1406 to be associated with the purchase centroid 1306 associated with the consumer 1102. As illustrated in FIGS. 10 and 11, in the area 1502 the geographic centroid 1406 has been identified and the purchase centroid 1306 for the financial transactions 1602 has been identified. Based on this information, as discussed herein, a predetermined number of geographic centroids 1406 may be identified based on the distance from the purchase centroid 1306 to the corresponding geographic centroid 1406. In one embodiment, the predetermined number of geographic centroids may be 4, or may be all geographic centroids 1406 within a distance d4 from the purchase centroid 1306, as illustrated in FIG. 12.

Based on the distances d1, d2, d3, and d4, the plurality of geographic centroids 1702 may be identified as those geographic centroids 1702 that fit the criteria for establishing the predetermined number of centroids. The processing server 1204 may then update the corresponding consumer data entry 1302 to reflect geographic centroids 1702a, 1702b, 1702c, and 1702d as the associated geographic centroids 1310 associated with the purchase centroid 1306. In addition, the processing server 1204 may update the corresponding geographic data entry 1402 including each of the identified geographic areas 1704a, 1704b, 1704c, and 1704d as including the purchase centroid 1306 in the respective associated purchase centroids 1408.

### Method for Analyzing and Aggregating Spending Behaviors

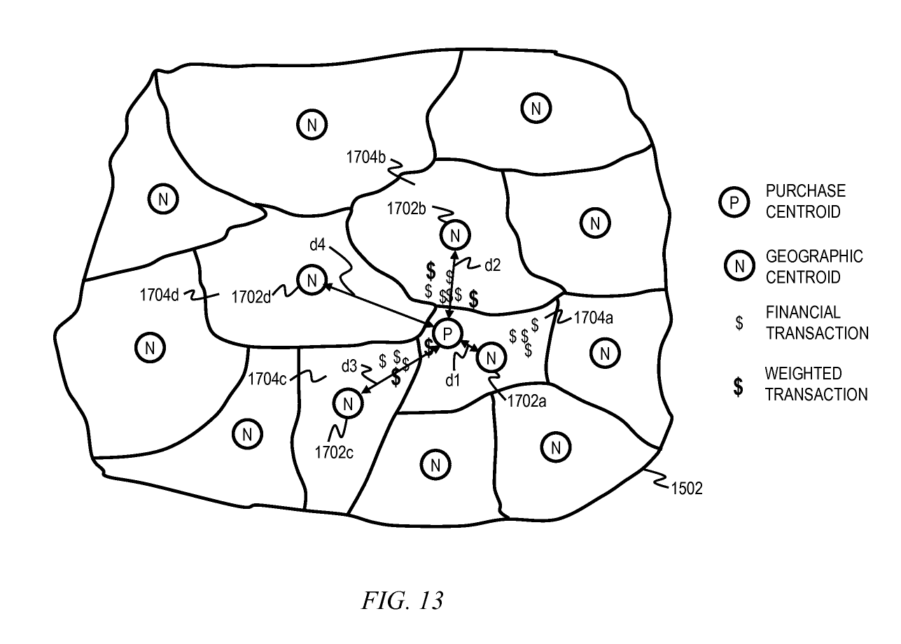

FIG. 13 illustrates a method 1800 for the analyzing and aggregation of spending behaviors for a geographic area.

In step 1802, a plurality of geographic centroids 1406 may be received. Each geographic centroid 1406 may be associated with a predefined geographic area 1404. In one embodiment, the geographic centroids 1406 may be stored in the geographic database 1110, as discussed above. In one embodiment, the geographic areas 1404 may be based on a zip code or postal code, may be defined by latitude or longitude boundaries, may be based on municipal boundaries, or a combination thereof

In step 1804, transaction information for a plurality of financial transactions including a plurality of consumers may be received (e.g., and subsequently stored in the transaction database 1112). Steps 1802 and 1804 may be performed by the receiving unit 1202. In some embodiments, step 1802 may include only the receipt of a plurality of geographic areas 1404, from which the corresponding geographic centroids 1406 may be calculated (e.g., by the calculating unit 1206).

In step 1806, it may be determined (e.g., by the processing unit 1204) if all consumers have been analyzed. If not, then, in step 1808, the calculating unit 1206 may calculate the purchase centroid 1306 for the next consumer (e.g., corresponding to the next unanalyzed consumer data entry 1302). Methods for calculating the purchase centroid 1306 will be apparent to persons having skill in the relevant art as discussed herein, such as identifying the geographic location of each financial transaction including the consumer and calculating the purchase centroid 1306 using known centroid calculation methods.

In step 1810, the processing unit 1204 may analyze the financial transactions including the consumer to determine consumer spend behaviors. In some embodiments, the consumer spend behaviors determined may be based on the application of the data. For example, the consumer spend behaviors may include spend propensity for a specific industry, such as the industry of the merchant 1104 requesting the information. The processing unit 1204 may store the analyzed spend behaviors in the corresponding consumer data entry 1302 in the consumer database 1114 as the included spending behaviors 1308. In step 1812, the processing unit 1204 may identify a predetermined number of geographic centroids near the purchase centroid 1306. In some embodiments, the predetermined number of geographic centroids may be based on distance to the purchase centroid (e.g., all geographic centroids within 20 miles), based on a specific number (e.g., the 5 closest geographic centroids) or other criteria as will be apparent to persons having skill in the relevant art.

In step 1814, the processing unit 1204 may associate the purchase centroid 1306 with the identified geographic centroids. Associating the purchase centroid 1306 with the identified geographic centroids may include storing, in the corresponding consumer data entry 1302, the associated geographic centroids 1310, or storing, in the corresponding geographic data entry 1402 for each identified geographic centroid, the purchase centroid 1306 as an associated purchase centroid 1408. Then, the method 1800 may return to step 1806 and again determine if all consumers have been analyzed.

Once all consumers have been analyzed, then, in step 1816, the processing unit 1204 may determine if all geographic areas 1404 (e.g., based on the corresponding geographic data entries 1402) have been analyzed. If they have not, then, in step 1818, the processing unit 1204 may aggregate the spending behaviors associated with each geographic data entry 1402. Aggregating the spending behaviors for each geographic data entry 1402 may include identifying the consumer data entry 1302 for each purchase centroid 1306 included in the associated purchase centroids 1408, and aggregating the corresponding spending behaviors 1308 for each identified consumer data entry 1302. In one embodiment, the processing unit 1204 may store the aggregated spending behaviors 1410 in the corresponding geographic data entry 1402. Following this, the processing unit 1204 may again determine, in step 1816, if all geographic areas 1404 have been analyzed. If all have been analyzed (e.g., spending behaviors aggregated for each geographic area 1404), then the method 1800 may be completed.

### Exemplary Method for Assigning Spending Behaviors to Geographic Areas

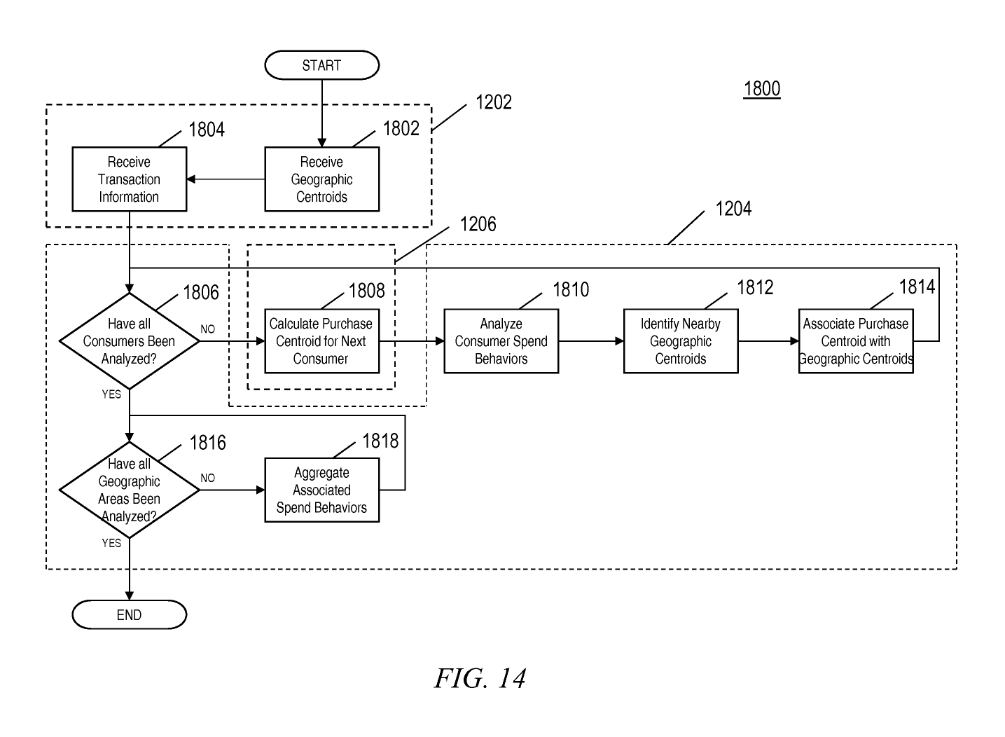

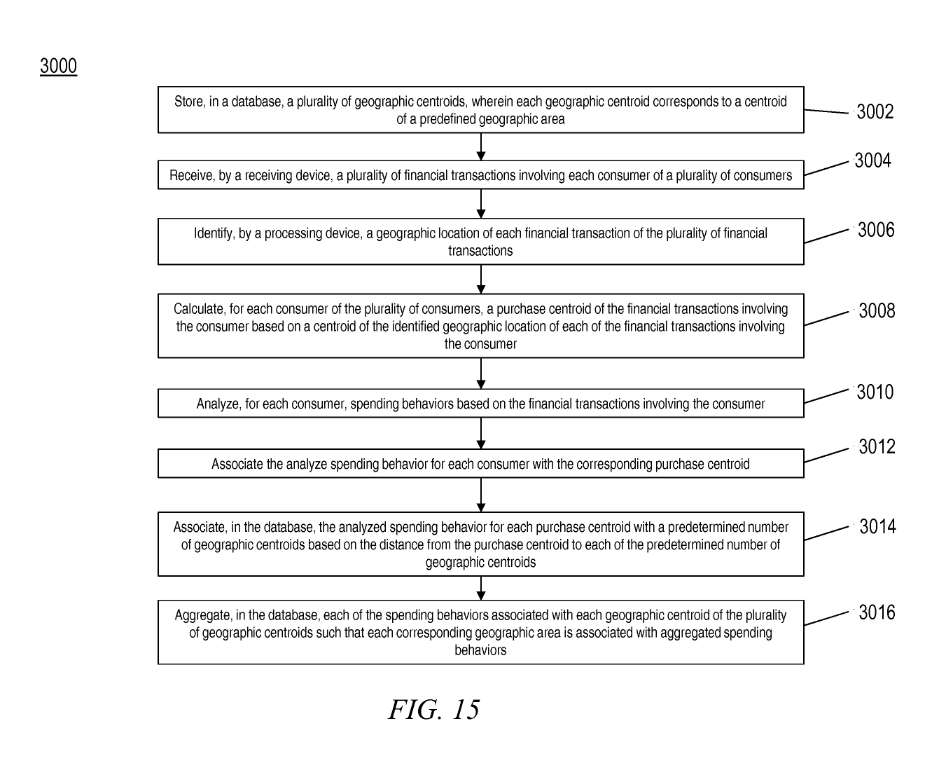

FIG. 14 illustrates a method 3000 for assigning consumer spend behaviors to geographic areas via the use of purchase and geographic centroids.

In step 3002, a plurality of geographic centroids (e.g., geographic centroids 1406) may be stored in a database (e.g., the geographic database 1110), wherein each geographic centroid 1406 corresponds to a centroid of a predefined geographic area (e.g., geographic area 1404). In one embodiment, the predefined geographic area may be based on a zip code or a postal code. In another embodiment, the predefined geographic area may be defined by latitude and longitude measurements. In yet another embodiment, the predefined geographic area may be based on municipal boundaries.

In step 3004, a plurality of financial transactions including each consumer of a plurality of consumers may be received by a receiving device (e.g., the receiving unit 1202). In step 3006, a processing device (e.g., the processing unit 1204) may identify a geographic location of each financial transaction of the plurality of financial transactions. In one embodiment, identifying the geographic location of each financial transaction may include identifying, in a database, the latitude and longitude of a merchant point of sale included in the financial transaction. In another embodiment, identifying the geographic location of each financial transaction may include identifying the geographic location of a mobile communication device used as a payment method in the respective financial transaction.

In step 3008, a purchase centroid (e.g., the purchase centroid 1306) of the financial transactions involving a consumer may be calculated (e.g., by the calculating unit 1206) for each consumer of the plurality of consumers, based on a centroid of the identified geographic location of each of the financial transactions involving the consumer. In one embodiment, calculating the purchase centroid 1306 of the financial transactions may include weighing or filtering the financial transactions based on predetermined factors. In a further embodiment, the predetermined factors may include at least one of: merchant code or type, product category, transaction amount, transaction frequency, and geographic location of the transaction. In another embodiment, the plurality of financial transactions may include only financial transactions of a predetermined category. In a further embodiment, the predetermined category may be based on at least one of: time of day, day of the week, month, season, home location, employment location, merchant code, product category, industry code, and transaction amount. In some embodiments, multiple purchase centroids may be calculated for each consumer, such as purchase centroids for each of a number of predetermined categories.

In step 3010, spending behaviors (e.g., the spending behaviors 1308) for each consumer may be analyzed (e.g., by the processing unit 1204) based on the financial transactions including the consumer. In one embodiment, the spending behaviors 1308 may include at least one of: propensity to spend, propensity to spend in a particular industry, frequency of spending, amount of spending, industry preference, brand preference, and time of spending. In step 3012, the analyzed spending behavior 1308 for each consumer may be associated with the corresponding purchase centroid 1306. Further details of consumer spending analysis can be found, e.g., in U.S. Patent Publication 2013-0024242, “Protecting Privacy in Audience Creation” of Villars et al., expressly incorporated by reference herein in its entirety for all purposes.

In step 3014, the analyzed spending behavior 1308 for each purchase centroid 1306 may be associated, in the geographic database 1110, with a predetermined number of geographic centroids 1310 based on the distance from the purchase centroid 1306 to each of the predetermined number of geographic centroids 1310. In one embodiment, the predetermined number of geographic centroids 1310 may be based on a privacy concern. In a further embodiment, the privacy concern may be such that no consumer is personally identifiable. In another embodiment, the predetermined number of geographic centroids 1310 may include all geographic centroids 1406 in a specified distance radial from the purchase centroid 1306.

In step 3016, each of the spending behaviors 1308 associated with each geographic centroid 1406 of the plurality of geographic centroids 1406 may be aggregated, in the geographic database 1110, such that each corresponding geographic area 1404 may be associated with the aggregated spending behaviors (e.g., the aggregated spending behaviors 1410).

The calculation of purchase centroids on the basis of financial transactions may be beneficial for merchants and advertisers by identifying consumers and spending behaviors for specific locations. It will be apparent to persons having skill in the relevant art that centroids may also be calculated on additional activities and my not be strictly limited to financial transactions. For example, centroids may be calculated based on social network activities (e.g., locations when a consumer posts to Facebook®, Twitter®, FourSquare®, etc.), locations where a consumer sends messages (e.g., short message service messages) or conducts calls from a mobile device, etc.

The identification of purchase centroids and associated spending behaviors may also have additional applications and be beneficial for advertisers and merchants in addition to those discussed herein, as will be apparent to persons having skill in the relevant art. For example, the analysis of purchase centroids based on dates may identify when a consumer moves from one location to another, which may present the consumer as ideal for receiving advertising for offers or services in a new location. Similarly, purchase centroids may identify a consumer that lives in multiple locations (e.g., a seasonal home), which may benefit merchants by knowing that the consumer need only be advertised to for certain periods. Additional uses for purchase centroids and aggregated spending behaviors as discussed herein will be apparent to persons having skill in the relevant art.

Techniques consistent with the present disclosure provide, among other features, systems and methods for assigning spend behaviors to geographic areas.

What is claimed is:

1. A method comprising the steps of:
using payment card transaction data, estimating residence locations for a plurality of payment card holders;
using payment card transaction data, estimating recurrent destinations for at least a first portion of said plurality of payment card holders;
identifying a plurality of pooled transit pick-up points in a geographic region of interest;
assigning each of at least a second portion of said payment card holders to at least one of said pooled transit pick-up points; and
identifying at least some of said payment card holders assigned to at least one of said pick-up points as potential riders of a pooled transit service.

2. The method of claim 1, further comprising offering said pooled transit service to said at least some of said payment card holders assigned to said at least one of said pick-up points.

3. The method of claim 2, wherein, in said offering step, said offering comprises offering said pooled transit service to less than all of said payment card holders assigned to said at least one of said pick-up points, further comprising targeting a subset of all of said payment card holders assigned to said at least one of said pick-up points to receive said offering.

4. The method of claim 3, wherein said targeting comprises targeting based on at least one of estimated current commuting time and estimated current commuting expense.

5. The method of claim 3, wherein said targeting comprises targeting based on affordability.

6. The method of claim 2, further comprising:
for at least one of said pooled transit pick-up points not having sufficient interested cardholders to justify said pooled transit service, examining a route, from said at least one of said pooled transit pick-up points not having sufficient interested cardholders, to a common recurring destination, for at least one other of said pooled transit pick-up points located close to said route; and
offering said pooled transit service to at least some of said payment card holders assigned to said at least one other of said pooled transit pick-up points located close to said route.

7. The method of claim 6, further comprising, for at least one of said pooled transit pick-up points not having sufficient interested cardholders to justify said pooled transit service even after said offering of said pooled transit service to said at least some of said payment card holders assigned to said at least one other of said pooled transit pick-up points located close to said route, combining said route with another route to another recurring destination, close to but different from said common recurring destination.

8. The method of claim 7, wherein said combining is carried out by searching routes to recurring destinations other than said common recurring destination in order from closest to furthest until there are sufficient interested cardholders to justify said pooled transit service.

9. The method of claim 2, further comprising, for at least one of said pooled transit pick-up points not having sufficient interested cardholders to justify said pooled transit service even after said offering of said pooled transit service to said at least some of said payment card holders assigned to said at least one other of said pooled transit pick-up points located close to said route, combining said route with another route to another recurring destination, close to but different from said common recurring destination.

10. The method of claim 9, wherein said combining is carried out by searching routes to recurring destinations other than said common recurring destination in order from closest to furthest until there are sufficient interested cardholders to justify said pooled transit service.

11. The method of claim 2, wherein said step of estimating said residence locations for said plurality of payment card holders using said payment card transaction data comprises taking a geocentroid of evening and weekend purchases of domestic-related items.

12. The method of claim 2, wherein said step of estimating said recurring destinations for said plurality of payment card holders using said payment card transaction data comprises identifying at least one frequent mid-week-day spending location.

13. The method of claim 2, wherein said step of assigning each of said at least second portion of said payment card holders to at least one of said pooled transit pick-up points comprises conducting a buffer operation with a geographic information system.

14. The method of claim 1, further comprising providing a system, wherein the system comprises: (i) at least one distinct software module embodied on a non-transitory computer-readable storage medium, (ii) a non-transitory geographic database, (iii) a non-transitory transaction database including said payment card transaction data, and (iv) a non-transitory consumer database; and wherein the at least one distinct software module comprises a database management system module;
wherein:
said estimating of said residence locations is carried out by said database management system module, executing on at least one hardware processor, querying said geographic database, said transaction database, and said consumer database;
said estimating of said recurrent destinations for at least said first portion of said plurality of payment card holders is carried out by said database management system module, executing on said at least one hardware processor, querying said geographic database, said transaction database, and said consumer database;
said identifying of said plurality of pooled transit pick-up points in said geographic region of interest is carried out at least by said database management system module, executing on said at least one hardware processor, querying said geographic database and said consumer database;
said assigning of each of said at least second portion of said payment card holders to said at least one of said pooled transit pick-up points is carried out at least by said database management system module, executing on said at least one hardware processor, querying said geographic database and said consumer database; and
said identifying of said at least some of said payment card holders assigned to said at least one of said pick-up points as potential riders of said pooled transit service is carried out at least by said database management system module, executing on said at least one hardware processor, querying said geographic database and said consumer database.

15. A system comprising:
a memory;
at least one processor operatively coupled to said memory; and
a persistent storage device operatively coupled to said memory and storing in a non-transitory manner instructions which when loaded into said memory cause said at least one processor to be operative to:
using payment card transaction data, estimate residence locations for a plurality of payment card holders;
using payment card transaction data, estimate recurrent destinations for at least a first portion of said plurality of payment card holders;
identify a plurality of pooled transit pick-up points in a geographic region of interest;
assign each of at least a second portion of said payment card holders to at least one of said pooled transit pick-up points; and
identify at least some of said payment card holders assigned to at least one of said pick-up points as potential riders of a pooled transit service.

16. The system of claim 15, wherein said persistent storage device further stores in a non-transitory manner instructions which when loaded into said memory cause said at least one processor to be operative to facilitate offering said pooled transit service to said at least some of said payment card holders assigned to said at least one of said pick-up points.

17. The system of claim 16, wherein said offering comprises offering said pooled transit service to less than all of said payment card holders assigned to said at least one of said pick-up points, and wherein said persistent storage device further stores in a non-transitory manner instructions which when loaded into said memory cause said at least one processor to be operative to target a subset of all of said payment card holders assigned to said at least one of said pick-up points to receive said offering.

18. The system of claim 16, wherein said persistent storage device further stores in a non-transitory manner instructions which when loaded into said memory cause said at least one processor to be operative to:
for at least one of said pooled transit pick-up points not having sufficient interested cardholders to justify said pooled transit service, examine a route, from said at least one of said pooled transit pick-up points not having sufficient interested cardholders, to a common recurring destination, for at least one other of said pooled transit pick-up points located close to said route; and
offer said pooled transit service to at least some of said payment card holders assigned to said at least one other of said pooled transit pick-up points located close to said route.

19. The system of claim 18, wherein said persistent storage device further stores in a non-transitory manner instructions which when loaded into said memory cause said at least one processor to be operative to, for at least one of said pooled transit pick-up points not having sufficient interested cardholders to justify said pooled transit service even after said offering of said pooled transit service to said at least some of said payment card holders assigned to said at least one other of said pooled transit pick-up points located close to said route, combine said route with another route to another recurring destination, close to but different from said common recurring destination.

20. The system of claim 19, wherein said combining is carried out by searching routes to recurring destinations other than said common recurring destination in order from closest to furthest until there are sufficient interested cardholders to justify said pooled transit service.

21. The system of claim 16, wherein said persistent storage device further stores in a non-transitory manner instructions which when loaded into said memory cause said at least one processor to be operative to, for at least one of said pooled transit pick-up points not having sufficient interested cardholders to justify said pooled transit service even after said offering of said pooled transit service to said at least some of said payment card holders assigned to said at least one other of said pooled transit pick-up points located close to said route, combine said route with another route to another recurring destination, close to but different from said common recurring destination.

22. The system of claim 21, wherein said combining is carried out by searching routes to recurring destinations other than said common recurring destination in order from closest to furthest until there are sufficient interested cardholders to justify said pooled transit service.

23. The system of claim 15, wherein said instructions on said persistent storage device comprise at least one distinct software module, and wherein said distinct software modules comprise a database management system module module;
further comprising:
a non-transitory geographic database;
a non-transitory transaction database including said payment card transaction data; and
a non-transitory consumer database;
wherein:
said database management system module comprises said instructions which cause said at least one processor to estimate said residence locations, by querying said geographic database, said transaction database, and said consumer database;
said database management system module comprises said instructions which cause said at least one processor to estimate said recurrent destinations for at least said first portion of said plurality of payment card holders, by querying said geographic database, said transaction database, and said consumer database;
said database management system module comprises at least a portion of said instructions which cause said at least one processor to identify said plurality of pooled transit pick-up points in said geographic region of interest, by querying said geographic database and said consumer database;
said database management system module comprises at least a portion of said instructions which cause said at least one processor to assign each of said at least second portion of said payment card holders to said at least one of said pooled transit pick-up points, by querying said geographic database and said consumer database; and
said database management system module comprises at least a portion of said instructions which cause said at least one processor to identify said at least some of said payment card holders assigned to said at least one of said pick-up points as potential riders of said pooled transit service, by querying said geographic database and said consumer database.

24. An apparatus comprising:
means for, using payment card transaction data, estimating residence locations for a plurality of payment card holders;
means for, using payment card transaction data, estimating recurrent destinations for at least a first portion of said plurality of payment card holders;
means for identifying a plurality of pooled transit pick-up points in a geographic region of interest;
means for assigning each of at least a second portion of said payment card holders to at least one of said pooled transit pick-up points; and
means for identifying at least some of said payment card holders assigned to at least one of said pick-up points as potential riders of a pooled transit service.

25. An article of manufacture comprising a computer program product, said computer program product comprising:
a tangible computer-readable recordable storage medium, storing in a non-transitory manner computer readable program code which, when loaded into a memory, configures at least one associated processor to be operative to:
using payment card transaction data, estimate residence locations for a plurality of payment card holders;
using payment card transaction data, estimate recurrent destinations for at least a first portion of said plurality of payment card holders;
identify a plurality of pooled transit pick-up points in a geographic region of interest;
assign each of at least a second portion of said payment card holders to at least one of said pooled transit pick-up points; and
identify at least some of said payment card holders assigned to at least one of said pick-up points as potential riders of a pooled transit service.
